(19) United States
(12) Patent Application Publication
(10) Pub. No.: US 2023/0259044 A1
(43) Pub. Date: Aug. 17, 2023

(54) ELECTROPHOTOGRAPHIC PHOTOSENSITIVE MEMBER, PROCESS CARTRIDGE, ELECTROPHOTOGRAPHIC APPARATUS, AND METHOD FOR PRODUCING ELECTROPHOTOGRAPHIC PHOTOSENSITIVE MEMBER

(71) Applicant: CANON KABUSHIKI KAISHA, Tokyo (JP)

(72) Inventors: HARUHIKO MITSUDA, Chiba (JP); RYOICHI TOKIMITSU, Chiba (JP); EILEEN TAKEUCHI, Tokyo (JP); JUN OHIRA, Ibaraki (JP); Toshiyasu Shirasuna, Shizuoka (JP); IKUYO KUROIWA, Tokyo (JP); TSUYOSHI SHIMADA, Chiba (JP); TAKANORI UENO, Kanagawa (JP); KENICHI IKARI, Chiba (JP)

(21) Appl. No.: 18/161,113

(22) Filed: Jan. 30, 2023

(30) Foreign Application Priority Data
Feb. 14, 2022 (JP) 2022-020570

(51) Int. Cl. G03G 5/06; G03G 15/02; G03G 5/05; G03G 21/18

(52) U.S. Cl. CPC G03G 5/06147; G03G 15/0233; G03G 5/0564; G03G 21/1814

(57) ABSTRACT

The present disclosure provides an electrophotographic photosensitive member having excellent dispersibility of fluorine atom-containing resin particles, and excellent durability, with an occurrence of a ghost suppressed. In the electrophotographic photosensitive member having a surface layer, the surface layer includes a fluorine atom-containing resin particle, a binder material, a charge transport substance, and a polymer A having a specific structural unit, wherein the binder material is a thermoplastic resin, and a film thickness of the surface layer is 35 μm or larger and 50 μm or smaller.

### BACKGROUND OF THE INVENTION

### Field of the Invention

The present disclosure relates to an electrophotographic photosensitive member, a process cartridge and an electrophotographic apparatus each having the electrophotographic photosensitive member, and a method for producing the electrophotographic photosensitive member.

### Description of the Related Art

As an electrophotographic photosensitive member to be mounted in an electrophotographic apparatus, an electrophotographic photosensitive member containing an organic photoconductive substance (charge generation substance) is widely used. In recent years, for the purpose of extending the life of the electrophotographic photosensitive member and enhancing an image quality at the time of repeated use, the electrophotographic photosensitive member is required to have enhanced mechanical durability (abrasion resistance).

As a technology for enhancing the abrasion resistance of the electrophotographic photosensitive member, there is a method of causing a surface layer of the electrophotographic photosensitive member to contain a fluorine atom-containing resin particle, and reducing the friction between the surface layer and a contact member such as a cleaning blade. Japanese Patent Application Laid-Open No. H06-332219 discloses a technology of forming a surface layer, by using a dispersion liquid of the fluorine atom-containing resin particle such as a polytetrafluoroethylene resin particle, as a coating liquid for the surface layer.

In addition, there is known a method of using a (meth)acrylic polymer containing a fluorine atom as a dispersing agent for the fluorine atom-containing resin particle, for the purpose of enhancing dispersibility, when the dispersion liquid of the fluorine atom-containing resin particle is prepared. Japanese Patent Application Laid-Open No. 2012-189715 and Japanese Patent Application Laid-Open No. 2009-104145 disclose technologies of enhancing the dispersibility of the fluorine atom-containing resin particle, with the use of a fluorine atom-containing (meth) acrylic polymer having a specific structure as a dispersing agent.

Japanese Patent Application Laid-Open No. 2021-47236 discloses an electrophotographic photosensitive member that has an outermost surface layer which contains a fluorine-based graft polymer and a fluorine atom-containing resin particle, wherein the fluorine-based graft polymer contains a structural unit having an acidic group having a pKa of 3 or smaller.

### SUMMARY OF THE INVENTION

However, in the technologies disclosed in Japanese Patent Application Laid-Open No. 2012-189715 and Japanese Patent Application Laid-Open No. 2009-104145, there has been a case where a ghost is aggravated, though a surface layer excellent in dispersibility of fluorine atom-containing resin particles is obtained. In particular, in a surface layer containing a thermoplastic resin as a binder material, there is a problem that the ghost is remarkably aggravated, when a film thickness of the surface layer is increased for the purpose of improving the durability. Accordingly, there has been a room for improvement in suppressing an occurrence of the ghost in the electrophotographic photosensitive member.

At least one aspect of the present disclosure is directed to providing an electrophotographic photosensitive member in which the ghost is suppressed.

In addition, another aspect of the present disclosure is directed to providing a process cartridge which mounts the electrophotographic photosensitive member thereon, and an electrophotographic apparatus equipped with the process cartridge.

Furthermore, another aspect of the present disclosure is directed to providing a method for producing the electrophotographic photosensitive member.

According to one aspect of the present disclosure, provided is an electrophotographic photosensitive member, wherein a surface layer of the electrophotographic photosensitive member includes a fluorine atom-containing resin particle, a binder material, a charge transport substance, and a polymer A having a structural unit represented by the following formula (1) and a structural unit represented by the following formula (2), and wherein the binder material is a thermoplastic resin, and a film thickness of the surface layer is 35 μm or larger and 50 μm or smaller.

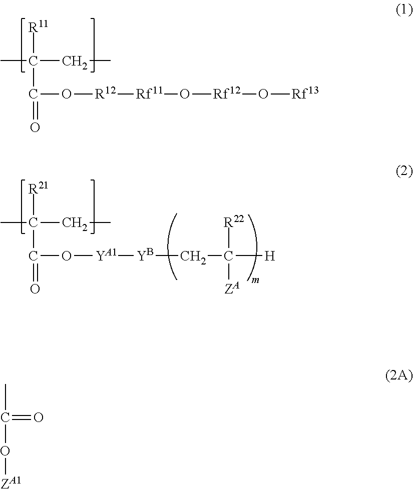

In the formula (1),

R¹¹ represents a hydrogen atom or a methyl group:

R¹² represents an ethylene group, a methylene group or a single bond;

Rf¹¹ and Rf¹² each independently represent a perfluoroalkylene group having 1 or more and 5 or less carbon atoms, or a perfluoroalkylidene group having 1 or more and 5 or less carbon atoms; and

Rf¹³ represents a perfluoroalkyl group having 1 or more and 5 or less carbon atoms.

In the formula (2),

Y^{A1} represents an unsubstituted alkylene group;

Y^{B} represents an unsubstituted alkylene group, an alkylene group substituted with a halogen atom, an alkylene group substituted with a hydroxy group, an ester bond (—COO—), an amide bond (—NHCO—) or a urethane bond (—NHCOO—), or alternatively a divalent linking group that can be derived from a combination of one or more selected from the above groups and bonds, and —O— or —S—, or alternatively a single bond;

Z^{A} represents a structure represented by the above formula (2A),

a cyano group or a phenyl group,

R²¹ and R²² each independently represent a hydrogen atom or a methyl group; and

m is an integer of 25 or larger and 150 or smaller.

In the formula (2A),

Z^{A1} represents an alkyl group having 1 or more and 4 or less carbon atoms.

In a structural unit represented by the formula (2), when Y^{B} represents an ester bond, —Y^{A1}-Y^{B}—CH₂— may be any one of —Y^{A1}—CO—O—CH₂— and —Y^{A1}—O—CO—CH₂—, and is preferably —Y^{A1}—CO—O—CH₂—. In addition, in the formula (2), when Y^{B} represents an amide bond, —Y^{A1}—Y^{B}—CH₂— may be any one of —Y^{A1}—NH—CO—CH₂— and —Y^{A1}—CO—NH—CH₂—, and is preferably —Y^{A1}—NH—CO—CH₂—. In addition, in the structural unit represented by the formula (2), when Y^{B} is a urethane bond, —Y^{A1}—Y^{B}—CH₂— may be any one of —Y^{A1}—NH—CO—O—CH₂— and —Y^{A1}—O—CO—NH—CH₂—, and is preferably —Y^{A1}—NH—CO—O—CH₂—.

In addition, according to another aspect of the present disclosure, provided is a process cartridge that integrally supports the electrophotographic photosensitive member, and at least one unit selected from the group consisting of a charging unit, a developing unit and a cleaning unit, and that is detachably attachable to a main body of an electrophotographic apparatus.

In addition, according to another aspect of the present disclosure, provided is an electrophotographic apparatus including the electrophotographic photosensitive member, and a charging unit, an exposure unit, a developing unit and a transfer unit.

Furthermore, according to another aspect of the present disclosure, provided is a method for producing the electrophotographic photosensitive member.

Further features of the present invention will become apparent from the following description of exemplary embodiments with reference to the attached drawings.

### BRIEF DESCRIPTION OF THE DRAWINGS

FIG. 1 is a schematic view illustrating one example of a configuration of an electrophotographic photosensitive member of the present disclosure.

FIG. 2 illustrates a view illustrating one example of a schematic configuration of a process cartridge that mounts the electrophotographic photosensitive member of the present disclosure, therein.

FIG. 3 illustrates a view illustrating one example of a schematic configuration of an electrophotographic apparatus provided with a process cartridge that mounts an electrophotographic photosensitive member of the present disclosure, therein.

FIG. 4 illustrates a schematic view illustrating an image signal which is used for the evaluation of a ghost.

### DESCRIPTION OF THE EMBODIMENTS

Preferred embodiments of the present invention will now be described in detail in accordance with the accompanying drawings.

The present disclosure will be described below in detail with reference to exemplary embodiments.

As a result of investigation by the present inventors, it has become clear that in a conventional technology, a technological problem occurs that a ghost is aggravated, when the surface layer contains a binder material and the binder material is a thermoplastic resin, in the case where the film thickness of the surface layer is increased. In particular, when the film thickness of the surface layer is 35 μm or larger, the aggravation of the ghost has been remarkable. It is assumed that the above technological problem occurs in the structure in which the film thickness of the surface layer is large, because there are more points at which electric charges stay than points at the time when the film thickness of the surface layer is small.

In order to solve the technological problem that has occurred in the above conventional technology, the present inventors have studied a material to be contained in the surface layer, and as a result, have found that when the surface layer contains a polymer A having a specific structure, an electrophotographic photosensitive member in which an occurrence of the ghost is suppressed can be obtained, even when the film thickness of the surface layer has been increased.

Specifically, it has been found that when the surface layer contains the fluorine atom-containing resin particle, a binder material, a charge transport substance, and the polymer A having a structural unit represented by the following formula (1) and a structural unit represented by the following formula (2), and when the binder material is a thermoplastic resin, and the film thickness of the surface layer is 35 μm or larger and 50 μm or smaller, there can be provided an electrophotographic photosensitive member having excellent dispersibility of fluorine atom-containing resin particles in the surface layer, and excellent durability, with suppressed ghost.

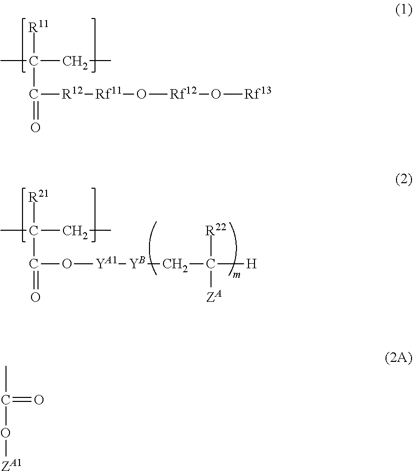

In the formula (1),

R¹¹ represents a hydrogen atom or a methyl group,

R¹² represents an ethylene group, a methylene group or a single bond,

Rf¹¹ and Rf¹² each independently represent a perfluoroalkylene group having 1 or more and 5 or less carbon atoms, or a perfluoroalkylidene group having 1 or more and 5 or less carbon atoms, and

Rf¹³ represents a perfluoroalkyl group having 1 or more and 5 or less carbon atoms.
In the formula (2),

Y^{A1} represents an unsubstituted alkylene group;

Y^{B} represents an unsubstituted alkylene group, an alkylene group substituted with a halogen atom, an alkylene group substituted with a hydroxy group, an ester bond (—COO—), an amide bond (—NHCO—) or a urethane bond (—NHCOO—), or alternatively a divalent linking group that can be derived from a combination of one or more selected from the above groups and bonds, and —O— or —S—, or alternatively a single bond;

Z^{A} represents a structure represented by the above formula (2A), a cyano group or a phenyl group;

R²¹ and R²² each independently represent a hydrogen atom or a methyl group; and

m is an integer of 25 or larger and 150 or smaller.

In the formula (2A),

Z^{A1} represents an alkyl group having 1 or more and 4 or less carbon atoms.

The present inventors assume the reason why the electrophotographic photosensitive member of the present disclosure is excellent in the dispersibility of the fluorine atom-containing resin particles in the surface layer, and is excellent in an effect of suppressing the ghost in the case where the film thickness of the surface layer is increased to 35 μm or larger, in the following way.

The present inventors assume the cause of the ghost which occurs in the surface layer containing the fluorine atom-containing resin particle and the thermoplastic resin as the binder material when the film thickness of the surface layer is increased to 35 μm or larger is that electric charges stay in the fluorine atom-containing resin particles. Here, the present inventors think that the polymer A having the structural unit represented by the above formula (1) and the structural unit represented by the above formula (2) effectively function as a dispersing agent for the fluorine atom-containing resin particle, in a process of preparing a coating liquid for the surface layer for forming the surface layer of the electrophotographic photosensitive member. It is assumed that a structure containing a —(CF₂)ₙ— chain of the structural unit represented by the above formula (1) in the polymer A has satisfactory affinity with the fluorine atom-containing resin particle, and is located in the vicinity of the fluorine atom-containing resin particle even after the surface layer has been formed. The inventors of the present invention assume that when the structure containing the —(CF₂)ₙ— chain is located in the vicinity of a fluorine atom, and when in the structure, an oxygen atom is caused to exist between the —(CF₂)ₙ— chain and the —(CF₂)ₙ— chain, an effect of releasing electric charges from the fluorine atom-containing resin particles to the charge transport substance via the oxygen atom is obtained, trapping of electric charges is suppressed, and thereby, the occurrence of the ghost is suppressed. In the formula (1), Rf¹¹ and Rf¹² are a perfluoroalkylene group or a perfluoroalkylidene group, and it has been found that when the number of each carbon atom is 1 or larger and 5 or smaller, an effect of suppressing ghost can be obtained. It is assumed that when the number of carbon atoms of each of the perfluoroalkylene group and the perfluoroalkylidene group of Rf¹¹ and Rf¹² in the formula (1) is larger than 5, electric charges stay in the perfluoroalkylene group and/or the perfluoroalkylidene group, and thereby, an effect of suppressing charge trapping via the oxygen atom is not obtained. In the formula (1), Rf¹³ is a perfluoroalkyl group, and it has been found that when the number of the carbon atoms is 1 or larger and 5 or smaller, an effect of suppressing the ghost is obtained. It is assumed that when the number of carbon atoms of the perfluoroalkyl group of Rf¹³ in the formula (1) is larger than 5, electric charges stay in the perfluoroalkyl group, and thereby, an effect of suppressing the charge trapping via the oxygen atom is not obtained.

In addition, it has been found that when m is 25 or larger and 150 or smaller, in a repeating structure (structure in which number of repetitions is represented by m) of the structural unit represented by the formula (2) in the polymer A, the above effect of suppressing the ghost is obtained. It is assumed that when m is larger than 150, a large amount of the above repeating structure enters in between the charge transport substance and the oxygen atom between the —(CF₂)ₙ— chain and the —(CF₂)ₙ— chain, and obstructs the exchange of electric charges, and thereby the effect of suppressing the ghost is not obtained. It is assumed that when m is smaller than 25, the distance between the fluorine atom-containing resin particles in the surface layer becomes short, accordingly, the effect of suppressing the trapping of electric charges is not sufficiently obtained, and the effect of suppressing the ghost is not obtained.

We believe that the effects of the present disclosure can be achieved by the synergistic effects of each configuration, as in the mechanism described above.

<Electrophotographic Photosensitive Member>

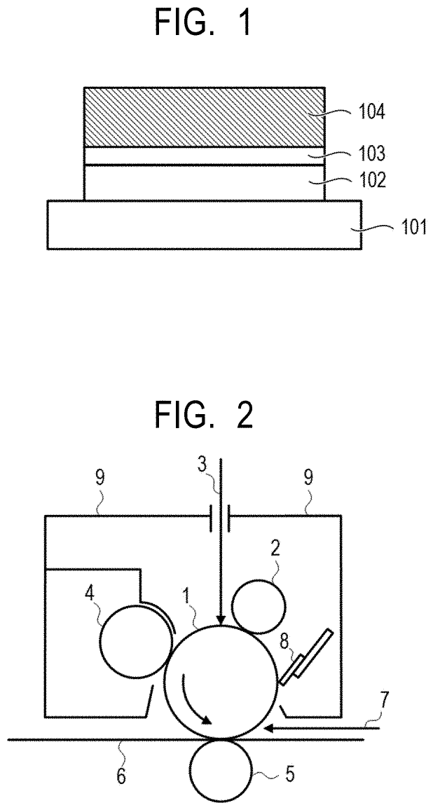

FIG. 1 illustrates one example of a layer structure of the electrophotographic photosensitive member of the present disclosure. In FIG. 1, an undercoat layer 102, a charge generation layer 103, and a charge transport layer 104 are layered on a support 101. The photosensitive layer may be configured to be a multilayer type photosensitive layer having a charge generation layer and a charge transport layer, or may be configured to be a single-layer type photosensitive layer containing a charge generation substance and a charge transport substance.

In the present disclosure, the outermost layer of the electrophotographic photosensitive member is defined as the surface layer.

A method for producing the electrophotographic photosensitive member of the present disclosure is, for example, a method including preparing a coating liquid of each layer which will be described later, applying desired layers sequentially, and drying the layers. Examples of the application method of the coating liquid at this time include dip coating, spray coating, inkjet coating, roll coating, die coating, blade coating, curtain coating, wire bar coating and ring coating. Among the methods, the dip coating is preferable, from the viewpoints of efficiency and productivity.

The support and each layer will be described below.

<Support>

It is preferable that the support of the electrophotographic photosensitive member is a member having electroconductivity (electroconductive support). In addition, shapes of the support include a cylindrical shape, a belt shape and a sheet shape. Among the shapes, it is preferable to be the cylindrical support. In addition, the surface of the support may be subjected to electrochemical treatment such as anodization, blast treatment, and cutting treatment.

As a material of the support, a metal, a resin, glass and the like are preferable.

Examples of the metal include aluminum, iron, nickel, copper, gold, stainless steel, and alloys thereof. Among the metals, it is preferable to be an aluminum support using aluminum.

In addition, it is preferable to impart the electroconductivity to the resin or the glass, by treatment such as mixing of or coating with an electroconductive material.

<Electroconductive Layer>

On the support, an electroconductive layer may be provided.

Due to the electroconductive layer being provided, the support can conceal scratches and unevenness on its surface and can control the reflection of light on its surface.

It is preferable that the electroconductive layer contains an electroconductive particle and a resin.

Examples of a material of the electroconductive particle include a metal oxide, a metal, and carbon black.

Examples of the metal oxides include zinc oxide, aluminum oxide, indium oxide, silicon oxide, zirconium oxide, tin oxide, titanium oxide, strontium titanate, magnesium oxide, antimony oxide and bismuth oxide. Examples of the metal include aluminum, nickel, iron, nichrome, copper, zinc and silver.

Among these substances, it is preferable to use a metal oxide particle as the electroconductive particle, and is more preferable to use, in particular, a titanium oxide particle, a tin oxide particle and a zinc oxide particle.

When a metal oxide particle is used as the electroconductive particle, the surface of the metal oxide particle may be treated with a silane coupling agent or the like, or the metal oxide particle may be doped with an element such as phosphorus or aluminum, or with an oxide thereof.

In addition, the electroconductive particle may have a multilayer structure having a core material particle and a covering layer which covers the particle. Examples of the core material particle include a titanium oxide particle, a barium sulfate particle and a zinc oxide particle. Examples of the covering layer include a metal oxide particle such as tin oxide.

In addition, when a metal oxide particle is used as the electroconductive particle, it is preferable for a volume-average particle size thereof to be 1 nm or larger and 500 nm or smaller, and is more preferable to be 3 nm or larger and 400 nm or smaller.

Examples of the resin include a polyester resin, a polycarbonate resin, a polyvinyl acetal resin, an acrylic resin, a silicone resin, an epoxy resin, a melamine resin, a polyurethane resin, a phenol resin and an alkyd resin.

In addition, the electroconductive layer may further contain a concealing agent such as a silicone oil, a resin particle and titanium oxide.

The electroconductive layer can be formed by preparing a coating liquid for the electroconductive layer, wherein the coating liquid contains each of the above materials and a solvent, forming a coating film of the coating liquid on the support, and drying the coating film. Examples of the solvent to be used for the coating liquid for the electroconductive layer include an alcohol-based solvent, a sulfoxide-based solvent, a ketone-based solvent, an ether-based solvent, an ester-based solvent and an aromatic hydrocarbon-based solvent. Examples of a dispersion method for dispersing the electroconductive particles in the coating liquid for the electroconductive layer include methods which use a paint shaker, a sand mill, a ball mill, and a liquid collision type high-speed dispersion machine, respectively.

It is preferable for an average film thickness of the electroconductive layer to be 1 μm or larger and 50 μm or smaller, and is particularly preferable to be 3 μm or larger and 40 μm or smaller.

<Undercoat Layer>

In the present disclosure, an undercoat layer may be provided on the support or the electroconductive layer. The undercoat layer which has been provided can thereby enhance an adhesion function between layers and impart a charge injection inhibition function.

It is preferable that the undercoat layer contains a resin. In addition, the undercoat layer may be formed as a cured film, by polymerization of a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, and a polyvinyl phenol resin, an alkyd resin, a polyvinyl alcohol resin, a polyethylene oxide resin, a polypropylene oxide resin, a polyamide resin, a polyamide acid resin, a polyimide resin, a polyamide-imide resin and a cellulose resin.

Examples of the polymerizable functional group which the monomer having a polymerizable functional group has include an isocyanate group, a block isocyanate group, a methylol group, an alkylated methylol group, an epoxy group, a metal alkoxide group, a hydroxy group, an amino group, a carboxyl group, a thiol group, a carboxylic acid anhydride group, and a carbon-carbon double bond group.

The undercoat layer may further contain an electron transport substance, a metal oxide particle, a metal particle, an electroconductive polymer or the like, for the purpose of enhancing electric characteristics. Among these substances, it is preferable to use an electron transport substance and a metal oxide particle.

Examples of the electron transport substance include a quinone compound, an imide compound, a benzimidazole compound, a cyclopentadienylidene compound, a fluorenone compound, a xanthone compound, a benzophenone compound, a cyano vinyl compound, an aryl halide compound, a silole compound, and a boron-containing compound. The undercoat layer may be formed as a cured film, by using an electron transport substance having a polymerizable functional group as an electron transport substance, and copolymerizing the electron transport substance with the above described monomer having the polymerizable functional group.

Examples of the metal oxide particle include particles of indium tin oxide, tin oxide, indium oxide, titanium oxide, strontium titanate, zinc oxide and aluminum oxide. A particle of silicon dioxide can also be used. Examples of the metal particle include particles of gold, silver and aluminum.

The metal oxide particle contained in the undercoat layer may be subjected to surface treatment with the use of a surface treatment agent such as a silane coupling agent, and be used.

As a method of surface-treating the metal oxide particle, a general method is used. Examples thereof include a dry method and a wet method.

The dry method is a method involving adding an aqueous alcohol solution, an organic solvent solution or an aqueous solution containing the surface treatment agent, to the metal oxide particles being stirred in a high-speed stirrable mixer such as a Henschel mixer, followed by uniform dispersion and then drying.

In addition, the wet method is a method of dispersing a metal oxide particle and the surface treatment agent in a solvent, by stirring or by a sand mill using glass beads or the like, and after the dispersion, removing the solvent by filtration or distillation under reduced pressure. After removal of the solvent, it is preferable to further performing baking at 100° C. or higher.

The undercoat layer may further contain an additive agent. For example, known materials can be contained therein, which include metal particles such as an aluminum particle; electroconductive substance particles such as carbon black; charge transport substances; metal chelate compounds; and organometallic compounds.

The undercoat layer can be formed by preparing a coating liquid for the undercoat layer, wherein the coating liquid contains each of the above materials and a solvent, forming this coating film on the support or the electroconductive layer, and drying and/or curing the coating film.

Examples of the solvent which is used in the coating liquid for the undercoat layer include organic solvents such as an alcohol, a sulfoxide, a ketone, an ether, an ester, an aliphatic halogenated hydrocarbon, and an aromatic compound. In the present disclosure, it is preferable to use an alcohol-based or ketone-based solvent.

Examples of a dispersion method for preparing the coating liquid for the undercoat layer include methods with the use of a homogenizer, an ultrasonic dispersing machine, a ball mill, a sand mill, a roll mill, a vibration mill, an attritor, and a liquid collision type high-speed dispersing machine.

It is preferable for an average film thickness of the undercoat layer to be 0.1 μm or larger and 50 μm or smaller, is more preferable to be 0.2 μm or larger and 40 μm or smaller, and is particularly preferable to be 0.3 μm or larger and 30 μm or smaller.

<Photosensitive Layer>

The photosensitive layer of the electrophotographic photosensitive member is mainly classified into (1) a multilayer type photosensitive layer and (2) a single-layer type photosensitive layer. (1) A multilayer type photosensitive layer is a photosensitive layer which includes a charge generation layer containing a charge generation substance, and a charge transport layer containing a charge transport substance. (2) A single-layer type photosensitive layer is a photosensitive layer containing both a charge generation substance and a charge transport substance.

(1) Multilayer Type Photosensitive Layer

The multilayer type photosensitive layer includes a charge generation layer and a charge transport layer.

(1-1) Charge Generation Layer

It is preferable that the charge generation layer contains a charge generation substance and a resin.

Examples of the charge generation substance include an azo pigment, a perylene pigment, a polycyclic quinone pigment, an indigo pigment and a phthalocyanine pigment. Among these pigments, the azo pigment and the phthalocyanine pigment are preferable. Among the phthalocyanine pigments, an oxytitanium phthalocyanine pigment, a chlorogallium phthalocyanine pigment and a hydroxygallium phthalocyanine pigment are preferable.

It is preferable for a content of the charge generation substance in the charge generation layer to be 40% by mass or more and 85% by mass or less, and is more preferable to be 60% by mass or more and 80% by mass or less, with respect to the total mass of the charge generation layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin and a polyvinyl chloride resin. Among these resins, the polyvinyl butyral resin is more preferable.

In addition, the charge generation layer may further contain an additive agent such as an antioxidizing agent and an ultraviolet absorbing agent. Specific examples thereof include a hindered phenol compound, a hindered amine compound, a sulfur compound, a phosphorus compound and a benzophenone compound.

The charge generation layer can be formed by preparing a coating liquid for the charge generation layer, wherein the coating liquid contains each of the above materials and a solvent, forming this coating film on the undercoat layer, and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

It is preferable for an average film thickness of the charge generation layer to be 0.1 μm or larger and 1 μm or smaller, and is more preferable to be 0.15 μm or larger and 0.4 μm or smaller.

(1-2) Charge Transport Layer

It is preferable that the charge transport layer contains a charge transport substance and a resin.

Examples of the charge transport substance include a polycyclic aromatic compound, a heterocyclic compound, a hydrazone compound, a styryl compound, an enamine compound, a triarylamine compound, and resins having a group derived from these substances. Among these materials, the triarylamine compound is preferable.

It is preferable for a content of the charge transport substance in the charge transport layer to be 25% by mass or more and 70% by mass or less, and is more preferable to be 30% by mass or more and 55% by mass or less, with respect to a total mass of the charge transport layer.

Examples of the resin include a polycarbonate resin, a polyarylate resin, an acrylic resin and a polystyrene resin. Among the resins, thermoplastic resins are preferable, and the polycarbonate resin and the polyarylate resin are particularly preferable.

A content ratio (mass ratio) of the charge transport substance to the resin is preferably 4:10 to 20:10, and is more preferably 5:10 to 12:10.

In addition, the charge transport layer may contain an additive agent such as an antioxidizing agent, an ultraviolet absorbing agent, a plasticizing agent, a leveling agent and a lubricant. The specific additive agents include a hindered phenol compound, a hindered amine compound, a sulfur compound, a phosphorus compound, a benzophenone compound, a siloxane modified resin, silicone oil, a polystyrene resin particle, a polyethylene resin particle, a boron nitride particle and a fluororesin particle.

The charge transport layer can be formed by preparing a coating liquid for the charge transport layer, wherein the coating liquid contains each of the above materials and a solvent, forming this coating film on the charge generation layer, and drying the coating film. Examples of the solvent to be used for the coating liquid include an alcohol-based solvent, a ketone-based solvent, an ether-based solvent, an ester-based solvent, and an aromatic hydrocarbon-based solvent. Among these solvents, the ether-based solvent or the aromatic hydrocarbon-based solvent is preferable.

It is preferable that an average film thickness of the charge transport layer is 5 μm or larger and 50 μm or smaller.

In the case where the charge transport layer is the surface layer, when the average film thickness of the charge transport layer is 35 μm or smaller, there is a case where sufficient durability as a photosensitive member is not obtained.

(2) Single-Layer Type Photosensitive Layer

The single-layer type photosensitive layer can be formed by preparing a coating liquid for the photosensitive layer, wherein the coating liquid contains a charge generation substance, a charge transport substance, a resin and a solvent; forming a coating film of the coating liquid on the support, the electroconductive layer or the undercoat layer; and drying the coating film. The charge generation substance, the charge transport substance and the resin are the same as the examples of the materials in the above “(1) multilayer type photosensitive layer”.

It is preferable that an average film thickness of the single-layer type photosensitive layer is 5 μm or larger and 50 μm or smaller.

In the case where the single-layer type photosensitive layer is the surface layer, when the average film thickness of the single-layer type photosensitive layer is 35 μm or smaller, there is a case where sufficient durability as a photosensitive member is not obtained.

<Surface Layer>

In the present disclosure, a layer located in the outermost layer of the electrophotographic photosensitive member is defined as the surface layer.

In the case of the electrophotographic photosensitive member having the previously described multilayer type photosensitive layer, the charge transport layer is the surface layer. In the case of the electrophotographic photosensitive member having the previously described single-layer type photosensitive layer, the photosensitive layer is the surface layer.

The surface layer of the electrophotographic photosensitive member of the present disclosure includes a fluorine atom-containing resin particle, a binder material, a charge transport substance, and a polymer A having a structural unit represented by the following formula (1) and a structural unit represented by the following formula (2).

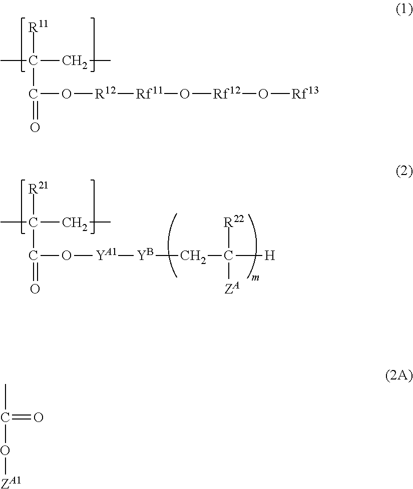

In the formula (1),

R¹¹ represents a hydrogen atom or a methyl group,

R¹² represents an ethylene group, a methylene group or a single bond,

Rf¹¹ and Rf¹² each independently represent a perfluoroalkylene group having 1 or more and 5 or less carbon atoms, or a perfluoroalkylidene group having 1 or more and 5 or less carbon atoms, and

Rf¹³ represents a perfluoroalkyl group having 1 or more and 5 or less carbon atoms.

In the formula (2),

Y^{A1} represents an unsubstituted alkylene group;

Y^{B} represents an unsubstituted alkylene group, an alkylene group substituted with a halogen atom, an alkylene group substituted with a hydroxy group, an ester bond (—COO—), an amide bond (—NHCO—) or a urethane bond (—NHCOO—), or alternatively a divalent linking group that can be derived from a combination of one or more selected from the above groups and bonds, and —O— or —S—, or alternatively a single bond;

Z^{A} represents a structure represented by the above formula (2A), a cyano group or a phenyl group;

R²¹ and R²² each independently represent a hydrogen atom or a methyl group; and

m is an integer of 25 or larger and 150 or smaller.

In the formula (2A),

Z^{A1} represents an alkyl group having 1 or more and 4 or less carbon atoms.

In addition, the binder material is a thermoplastic resin, and a film thickness of the surface layer is 35 μm or larger and 50 μm or smaller.

The present disclosure will be described below in detail with reference to exemplary embodiments of the surface layer.

<Fluorine Atom-Containing Resin Particle>

The surface layer of the electrophotographic photosensitive member of the present disclosure contains a fluorine atom-containing resin particle.

When the photosensitive layer of the electrophotographic photosensitive member is a multilayer type photosensitive layer and the charge transport layer is the surface layer, the content of the fluorine atom-containing resin particle is 5% by mass or more and 40% by mass or less with respect to the charge transport layer, is preferably 5% by mass or more and 15% by mass or less, and is more preferably 7% by mass or more and 10% by mass or less.

When the photosensitive layer of the electrophotographic photosensitive member is a single-layer type photosensitive layer and the photosensitive layer is the surface layer, the content of the fluorine atom-containing resin particle is 5% by mass or more and 40% by mass or less with respect to the photosensitive layer, is preferably 5% by mass or more and 15% by mass or less, and is more preferably 7% by mass or more and 10% by mass or less.

Examples of the resin contained in the fluorine atom-containing resin particle to be used in the present disclosure include the following resins: polytetrafluoroethylene resin, polychlorotrifluoroethylene resin, polytetrafluoroethylene propylene resin, polyvinyl fluoride resin, polyvinylidene fluoride resin or polydichlorodifluoroethylene resin. It is also preferable to use a particle containing a plurality of the above resins. In the above description, it is more preferable from the viewpoint of the enhancement of dispersibility that the fluorine atom-containing resin particle is the polytetrafluoroethylene resin.

In the cross-sectional observation of the surface layer, it is preferable that an arithmetic average (average size of primary particles) of long diameters of the primary particles in the fluorine atom-containing resin particles is 150 nm or larger and 300 nm or smaller, which are measured on the basis of a secondary electron image obtained by a scanning electron microscope, from the viewpoint of the enhancement of the dispersibility and the suppression of the potential fluctuation. Furthermore, it is preferable that an average size of primary particles of the fluorine atom-containing resin particles is 180 nm or larger and 250 nm or smaller.

It is preferable that an average value (average circularity) of circularities of the fluorine atom-containing resin particles is 0.75 or larger, which are calculated from the areas and circumferential lengths of the primary particles, which are measured on the basis of a secondary electron image obtained by a scanning electron microscope.

In order to control the measured values of the average size of primary particles and average circularity of the fluorine atom-containing resin particles contained in the surface layer of the electrophotographic photosensitive member of the present disclosure within the above range, such fluorine atom-containing resin particles can be used that the values of the average size of primary particles and average circularity fall within the above range, which are measured and calculated by the following method.

(Method for Measuring Average Size of Primary Particles and Average Circularity)

Specifically, in the Examples of the present disclosure, the average particle size and average circularity of the fluorine atom-containing resin particles contained in the surface layer of the electrophotographic photosensitive member were measured with the use of a field emission scanning electron microscope (FE-SEM), in the following way. The fluorine atom-containing resin particles were attached to a commercially available carbon electroconductive tape, the fluorine atom-containing resin particles which do not attach to the electroconductive tape were removed by compressed air, and platinum vapor deposition was performed. The deposited fluorine atom-containing resin particle was observed with the use of FE-SEM (S-4700) manufactured by Hitachi High-Tech Corporation. For information, the measurement conditions of FE-SEM are as follows.

Acceleration voltage: 2 kV

WD: 5 mm

Magnification: 20000 times

Number of pixels: 1280 pixels in height and 960 pixels in width (size per pixel: 5 nm)

From the obtained image, the Feret diameters of 100 particles were determined with the use of Image J (open-source software produced by National Institutes of Health (NIH)), and the average value was calculated and determined to be the average particle size.

In addition, the area and the circumferential length were determined in the same way; and the circularity was determined from the following expression (II), and the average value was calculated and determined to be the average circularity.

Circularity=4×π×(area)/(square of circumferential length) expression (II)

The fluorine atom-containing resin particles of the present disclosure may be used alone, or also in combination of two or more types thereof

<Binder Material>

The surface layer of the electrophotographic photosensitive member of the present disclosure contains a binder material.

In addition, the binder material is a thermoplastic resin.

The thermoplastic resin is preferably a polycarbonate resin or a polyarylate resin, and particularly preferably a polycarbonate resin.

<Charge Transport Substance>

The surface layer of the electrophotographic photosensitive member of the present disclosure contains a charge transport substance.

Examples of the charge transport substance include a polycyclic aromatic compound, a heterocyclic compound, a hydrazone compound, a styryl compound, an enamine compound, a triarylamine compound, and resins having a group derived from these substances. Among these substances, the triarylamine compound is preferable. The charge transport substance may be used alone, or a plurality of charge transport substances may be used in combination.

In the present disclosure, it is more preferable that the surface layer contains a compound represented by the following formula (3) as the charge transport substance, from the viewpoint of suppressing the ghost.

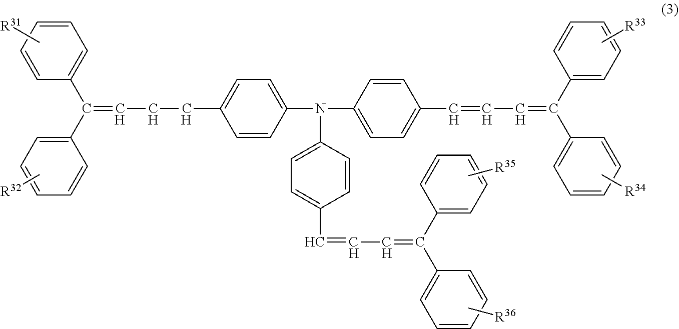

In the formula (3), R³¹, R³², R³³, R³⁴, R³⁵, and R³⁶ each independently represent a hydrogen atom, a methyl group, or a methoxy group.

<Polymer A>

In the polymer A, it is preferable that R¹² in the structural unit represented by the formula (1) is a methylene group, from the viewpoint of suppressing the ghost. In addition, it is preferable that Rf¹¹ and Rf¹² are each independently a perfluoroalkylene group or a perfluoroalkylidene group having 1 or more and 3 or less carbon atoms, and that Rf¹³ is a perfluoroalkyl group having 1 or more and 3 or less carbon atoms. In addition, it is preferable that the sum of the number of carbon atoms of Rf¹ to Rf¹³ is 6 or larger and 9 or smaller, from the viewpoint of the enhancement of the dispersibility of the fluorine atom-containing resin particles.

In the polymer A, it is preferable that —Y^{A1}-Y^{B}— in the structural unit represented by the formula (2) is a structure represented by —Y^{A1}-(Y^{A2})_{b}-(Y^{A3})_{c}-(Y^{A4})_{d}-(Y^{A5})ₑ-(Y^{A6})_{f}—.

Here,

Y^{A1} represents an unsubstituted alkylene group;

Y^{A2} represents a methylene group substituted with at least one selected from the group consisting of a hydroxy group and a halogen atom;

Y^{A3} represents an unsubstituted alkylene group;

Y^{A4} represents an ester bond, an amide bond or a urethane bond;

Y^{A5} represents an unsubstituted alkylene group;

Y^{A6} represents an oxygen atom or a sulfur atom; and

b, c, d, e and f each independently represent 0 or 1.

In addition, in the polymer A, it is preferable for the structural unit represented by the formula (1) to be 5% by number or more and 95% by number or less, is more preferable to be 50% by number or more and 95% by number or less, and is further preferable to be 70% by number or more and 90% by number or less.

In addition, in the polymer A, it is preferable for the structural unit represented by the formula (1) to be 0.1% by mass or more and 80% by mass or less, is more preferable to be 1% by mass or more and 80% by mass or less, and is further preferable to be 4% by mass or more and 66% by mass or less.

Furthermore, in the polymer A, it is preferable for a ratio of the structural unit represented by the formula (1) to the structural unit represented by the formula (2) to be 1:19 to 19:1 by molar ratio, is more preferable to be 1:1 to 19:1 by molar ratio, and is further preferable to be 7:3 to 9:1 by molar ratio.

In addition, in the surface layer, it is preferable for a content of the polymer A to be 2% by mass or more and 10% by mass or less with respect to the mass of the fluorine atom-containing resin particle, and is further preferable to be 4% by mass or more and 8% by mass or less, from the viewpoint of suppressing the ghost.

The surface layer may be free of a polymer that has a structural unit represented by the formula (1), a structural unit represented by the formula (2), and a structural unit having an acidic group of which the pKa is 3 or smaller, but preferably does not contain the polymer.

The pKa of the acidic group is determined by measurement employing a known method such as titration. Examples of the acidic group having a pKa of 3 or smaller include a sulfonic acid group (methanesulfonic acid: pKa −2.6), a phosphonic acid group (first dissociation: pKa 1.5), a phosphate group (first dissociation: pKa 2.12), and a fluoroalkyl carboxylic acid group (for example, trifluoroacetic acid: pKa −0.25, difluoroacetic acid: pKa 1.24, and monofluoroacetic acid: pKa 2.66).

From the viewpoint of the enhancement of the dispersibility of the fluorine atom-containing resin particles, the weight average molecular weight of the polymer A is preferably 16,000 or larger and 100,000 or smaller, and is more preferably 18,000 or larger and 80,000 or smaller.

The weight average molecular weight of the polymer A can be measured and calculated according to the following method.

(Measurement of Weight Average Molecular Weight by GPC)

The weight average molecular weight according to the present disclosure is measured with gel permeation chromatography (GPC), in the following way.

Firstly, the sample is dissolved in tetrahydrofuran (THF) over 24 hours at room temperature. Then, the obtained solution is filtered through a solvent-resistant membrane filter “Maeshori disc” (manufactured by Tosoh Corporation) having a pore diameter of 0.2 μm, and a sample solution is obtained. For information, the sample solution is adjusted so that the concentration of the components soluble in THE becomes approximately 0.8% by mass. The sample solution is subjected to the measurement under the following conditions.
Apparatus: HLC8120GPC (Detector: RI) (manufactured by Tosoh Corporation)
Column: seven sequences of Shodex KF-801, 802, 803, 804, 805, 806 and 807 (manufactured by Showadenkosya Co., Ltd.).
Eluent: tetrahydrofuran (THF)
Flow rate: 1.0 ml/min
Oven temperature: 40.0° C.
Amount of sample to be injected: 0.10 ml

When the molecular weight of the sample is calculated, a molecular weight calibration curve is used which is prepared with the use of a standard polystyrene resin (for example, trade name “TSK standard polystyrene F-850, F-450, F-288, F-128, F-80, F-40, F-20, F-10, F-4, F-2, F-1, A-5000, A-2500, A-1000 or A-500”, produced by Tosoh Corporation).

Examples of the structural unit represented by the formula (1) used in the present disclosure include structures shown in the following Table 1.

TABLE 1

| | Structural unit represented by formula (1) | | | | | |
|---|---|---|---|---|---|---|
| Number of | | | | | | Sum of the number |
| compound | | | | | | of carbon atoms of |
| example | R¹^{¹} | R^{¹}² | Rf¹¹ | Rf¹² | Rf¹³ | Rf¹¹ to Rf¹³ |
| u1-1 | —H | —CH₂— | —CF₂— | 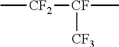 | —CF₂—CF₂—CF₂—CF₂—CF₃ | 9 |
| u1-2 | —H | —CH₂—CH₂— | —CF₂— | 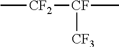 | —CF₂—CF₂—CF₂—CF₂—CF₃ | 9 |
| u1-3 | —H | Single bond | —CF₂— | 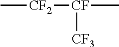 | —CF₂—CF₂—CF₂—CF₂—CF₃ | 9 |
| u1-4 | —CH₃ | —CH₂— | —CF₂— | 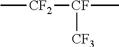 | —CF₂—CF₂—CF₂—CF₂—CF₃ | 9 |
| u1-5 | —H | —CH₂— | 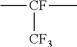 | 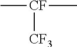 | —CF₂—CF₂—CF₂—CF₂—CF₃ | 9 |
| u1-6 | —H | —CH₂— | 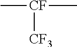 | —CF₂—CF₂— | —CF₂—CF₂—CF₂—CF₂—CF₃ | 9 |
| u1-7 | —H | —CH₂— | —CF₂—CF₂— | —CF₂—CF₂— | —CF₂—CF₂—CF₂—CF₂—CF₃ | 9 |
| u1-8 | —H | —CH₂— | —CF₂— | —CF₂—CF₂— | —CF₂—CF₂—CF₂—CF₂—CF₃ | 8 |
| u1-9 | —H | —CH₂— | 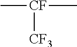 | 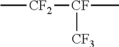 | —CF₂—CF₂—CF₂—CF₃ | 9 |
| u1-10 | —H | —CH₂— | —CF₂— | 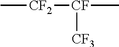 | —CF₂—CF₂—CF₂—CF₃ | 8 |
| u1-11 | —H | —CH₂— | —CF₂— | 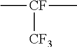 | —CF₂—CF₂—CF₂—CF₃ | 7 |
| u1-12 | —H | —CH₂— | —CF₂— | —CF₂—CF₂— | —CF₂—CF₂—CF₂—CF₃ | 7 |
| u1-13 | —H | —CH₂—CH₂— | —CF₂— | 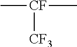 | —CF₂—CF₂—CF₂—CF₃ | 7 |
| u1-14 | —H | Single bond | —CF₂— | 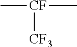 | —CF₂—CF₂—CF₂—CF₃ | 7 |
| u1-15 | —CH₃ | —CH₂— | —CF₂— | 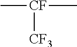 | —CF₂—CF₂—CF₂—CF₃ | 7 |
| u1-16 | —H | —CH₂— | 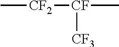 | 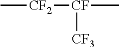 | —CF₂—CF₂—CF₃ | 9 |
| u1-17 | —H | —CH₂— | 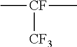 | 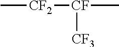 | —CF₂—CF₂—CF₃ | 8 |
| u1-18 | —H | —CH₂—CH₂— | 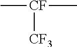 | 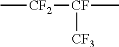 | —CF₂—CF₂—CF₃ | 8 |
| u1-19 | —H | Single bond | 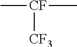 | 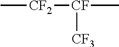 | —CF₂—CF₂—CF₃ | 8 |
| u1-20 | —CH₃ | —CH₂— | 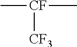 | 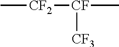 | —CF₂—CF₂—CF₃ | 8 |
| u1-21 | —H | —CH₂— | 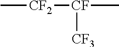 | 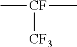 | —CF₂—CF₂—CF₃ | 8 |
| u1-22 | —H | —CH₂— | —CF₂— | 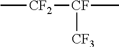 | —CF₂—CF₂—CF₃ | 7 |
| u1-23 | —H | —CH₂— | —CF₂— | 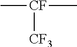 | —CF₂—CF₂—CF₃ | 6 |
| u1-24 | —H | —CH₂— | —CF₂— | —CF₂—CF₂— | —CF₂—CF₂—CF₃ | 6 |
| u1-25 | —H | —CH₂— | —CF₂—CF₂— | —CF₂—CF₂— | —CF₂—CF₃ | 6 |
| u1-26 | —H | —CH₂—CH₂— | —CF₂—CF₂— | —CF₂—CF₂— | —CF₂—CF₃ | 6 |
| u1-27 | —H | Single bond | —CF₂—CF₂— | —CF₂—CF₂— | —CF₂—CF₃ | 6 |
| u1-28 | —CH₃ | —CH₂— | —CF₂—CF₂— | —CF₂—CF₂— | —CF₂—CF₃ | 6 |
| u1-29 | —H | —CH₂— | —CF₂— | —CF₂— | —CF₃ | 3 |
| u1-30 | —H | —CH₂—CH₂— | —CF₂— | —CF₂— | —CF₃ | 3 |
| u1-31 | —H | Single bond | —CF₂— | —CF₂— | —CF₃ | 3 |
| u1-32 | —CH₃ | —CH₂— | —CF₂— | —CF₂— | —CF₃ | 3 |

Examples of the structural unit represented by the formula (2) used in the present disclosure include structures shown in the following Table 2.

TABLE 2-1

| | Structural unit represented by formula (2) | | | | | | |
|---|---|---|---|---|---|---|---|
| Number | R²¹ | R²² | Y^{A1} | Y^{B} | Z^{A} | Z^{A1} | m |
| u2-1 | —CH₃ | —CH₃ | —CH₂— | 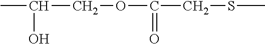 | Formula (2A) | —CH₃ | 60 |
| u2-2 | —CH₃ | —CH₃ | —CH₂— | 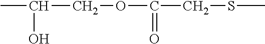 | Formula (2A) | —CH₃ | 25 |
| u2-3 | —CH₃ | —CH₃ | —CH₂— | 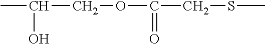 | Formula (2A) | —CH₃ | 150 |
| u2-4 | —CH₃ | —H | —CH₂— | 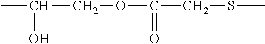 | Formula (2A) | —CH₃ | 60 |
| u2-5 | —H | —CH₃ | —CH₂— | 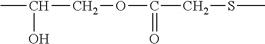 | Formula (2A) | —CH₃ | 60 |
| u2-6 | —H | —H | —CH₂— | 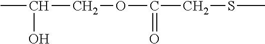 | Formula (2A) | —CH₃ | 60 |
| u2-7 | —CH₃ | —CH₃ | —CH₂—CH₂— | 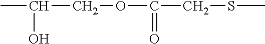 | Formula (2A) | —CH₃ | 60 |
| u2-8 | —CH₃ | —CH₃ | —CH₂— | 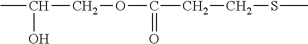 | Formula (2A) | —CH₃ | 60 |
| u2-9 | —CH₃ | —CH₃ | —CH₂—CH₂— | 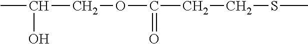 | Formula (2A) | —CH₃ | 60 |
| u2-10 | —CH₃ | —CH₃ | —CH₂— | 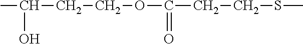 | Formula (2A) | —CH₃ | 60 |
| u2-11 | —CH₃ | —CH₃ | —CH₂—CH₂— | 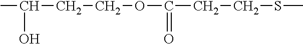 | Formula (2A) | —CH₃ | 60 |
| u2-12 | —CH₃ | —CH₃ | —CH₂— | 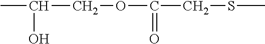 | Formula (2A) | —CH₂—CH₃ | 60 |
| u2-13 | —CH₃ | —CH₃ | —CH₂— | 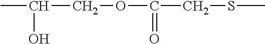 | Formula (2A) | —CH₂CH₂CH₂CH₃ | 60 |
| u2-14 | —CH₃ | —H | —CH₂— | 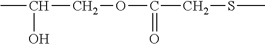 | Formula (2A) | —CH₂CH₂CH₂CH₃ | 60 |
| u2-15 | —CH₃ | —CH₃ | —CH₂— | 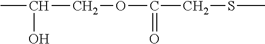 | Formula (2A) | —CH₂CH(CH₃)₂ | 60 |
| u2-16 | —CH₃ | —H | —CH₂— | 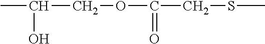 | Formula (2A) | —CH₂CH(CH₃)₂ | 60 |
| u2-17 | —CH₃ | —CH₃ | —CH₂— | 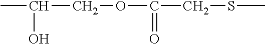 | Formula (2A) | —C(CH₃)₃ | 60 |
| u2-18 | —CH₃ | —H | —CH₂— | 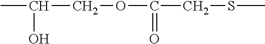 | Formula (2A) | —C(CH₃)₃ | 60 |
| u2-19 | —CH₃ | —H | —CH₂— | 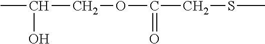 | Phenyl group | — | 60 |
| u2-20 | —CH₃ | —H | —CH₂— | 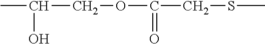 | Cyano group | — | 60 |
| u2-21 | —CH₃ | —CH₃ | —CH₂—CH₂— | 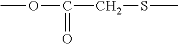 | Formula (2A) | —CH₃ | 60 |
| u2-22 | —CH₃ | —CH₃ | —CH₂—CH₂— | 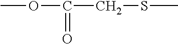 | Formula (2A) | —CH₃ | 60 |
| u2-23 | —H | —CH₃ | —CH₂—CH₂— | 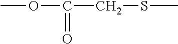 | Formula (2A) | —CH₃ | 60 |
| u2-24 | —CH₃ | —CH₃ | —CH₂— | 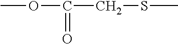 | Formula (2A) | —CH₃ | 60 |
| u2-25 | —CH₃ | —CH₃ | —CH₂CH₂CH₂CH₂— | 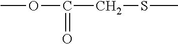 | Formula (2A) | —CH₃ | 60 |
| u2-26 | —CH₃ | —CH₃ | —CH₂—CH₂— | 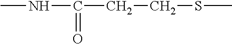 | Formula (2A) | —CH₃ | 60 |
| u2-27 | —H | —CH₃ | —CH₂—CH₂— | 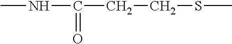 | Formula (2A) | —CH₃ | 60 |
| u2-28 | —CH₃ | —CH₃ | —CH₂—CH₂— | 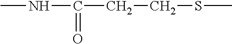 | Formula (2A) | —CH₃ | 60 |
| u2-29 | —CH₃ | —CH₃ | —CH₂—CH₂— | 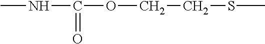 | Formula (2A) | —CH₃ | 60 |
| u2-30 | —H | —CH₃ | —CH₂—CH₂— | 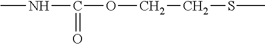 | Formula (2A) | —CH₃ | 60 |
| u2-31 | —CH₃ | —CH₃ | —CH₂—CH₂— | 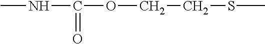 | Formula (2A) | —CH₃ | 60 |
| u2-32 | —CH₃ | —H | —CH₂—CH₂— | 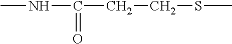 | Formula (2A) | —CH₃ | 60 |
| u2-33 | —H | —H | —CH₂—CH₂— | 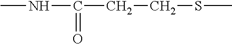 | Formula (2A) | —CH₃ | 60 |
| u2-34 | —CH₃ | —H | —CH₂—CH₂— | 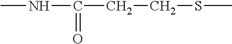 | Formula (2A) | —CH₃ | 60 |
| u2-35 | —CH₃ | —H | —CH₂—CH₂— | 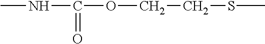 | Formula (2A) | —CH₃ | 60 |
| u2-36 | —H | —H | —CH₂—CH₂— | 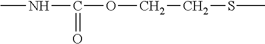 | Formula (2A) | —CH₃ | 60 |
| u2-37 | —CH₃ | —H | —CH₂—CH₂— | 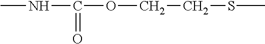 | Formula (2A) | —CH₃ | 60 |

<Process Cartridge and Electrophotographic Apparatus>

The electrophotographic photosensitive member of the present disclosure may be one of components of a process cartridge or an electrophotographic apparatus. A process cartridge integrally supports the electrophotographic photosensitive member described hitherto, and at least one unit selected from the group consisting of a charging unit, a developing unit, a transfer unit and a cleaning unit; and is detachably attachable to a main body of an electrophotographic apparatus. In addition, the electrophotographic apparatus includes the electrophotographic photosensitive member described hitherto, a charging unit, an exposure unit, a developing unit and a transfer unit.

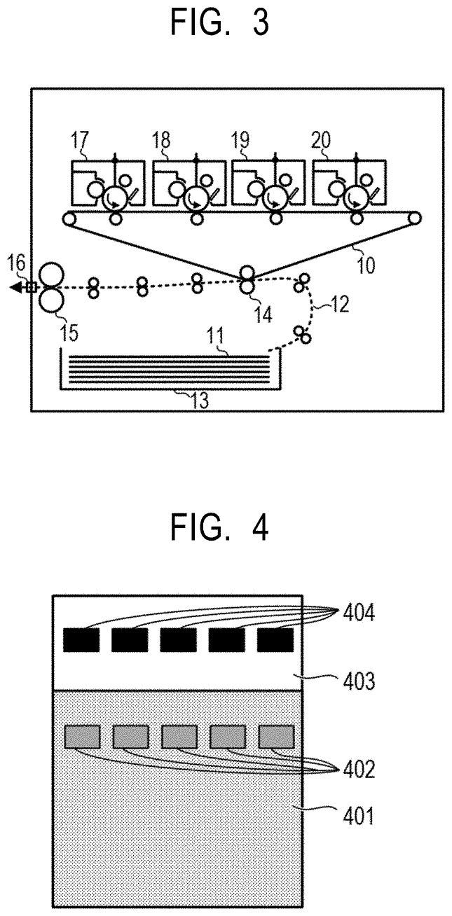

FIG. 2 illustrates a configuration of a process cartridge equipped with the electrophotographic photosensitive member of the present disclosure; and FIG. 3 illustrates one example of a schematic configuration of an electrophotographic apparatus including the process cartridge of FIG. 2.

In FIG. 2, a cylindrical electrophotographic photosensitive member 1 is rotationally driven at a predetermined peripheral velocity in the arrow direction. The peripheral surface of the electrophotographic photosensitive member 1 which is rotationally driven is uniformly electrostatically charged to a predetermined positive or negative potential by a charging unit 2. Subsequently, the charged peripheral surface of the electrophotographic photosensitive member 1 receives exposure light (image exposure light) 3 which is output from an exposure unit (not illustrated) such as slit exposure or laser beam scanning exposure. Thus, electrostatic latent images corresponding to a target image are sequentially formed on the peripheral surface of the electrophotographic photosensitive member 1. As the voltage to be applied to the charging unit (charging roller or the like) 2, any one of a voltage obtained by superimposing an AC component on a DC component or a voltage of only a DC component may be used.

The electrostatic latent image formed on the peripheral surface of the electrophotographic photosensitive member 1 is developed by a toner which is contained in a developer of the developing unit 4, and becomes a toner image. Subsequently, the toner image formed and carried on the peripheral surface of the electrophotographic photosensitive member 1 is sequentially transferred onto a transfer material (paper, intermediate transfer body or the like) 6 by a transfer bias applied from a transfer unit (transfer roller or the like) 5. The transfer material 6 is fed in synchronization with the rotation of the electrophotographic photosensitive member 1.

After the transfer of the toner image, the surface of the electrophotographic photosensitive member 1 is submitted to diselectrification by a pre-exposure light 7 emitted from a pre-exposure unit (not illustrated), then a transfer residual toner thereon is removed by a cleaning unit 8, and thereby the resultant surface is cleaned. The electrophotographic photosensitive member 1 is repeatedly used for image formation. The pre-exposure unit may be set before or after the cleaning process, and the pre-exposure unit is not necessarily required.

The electrophotographic photosensitive member 1 may be mounted on an electrophotographic apparatus such as a copying machine or a laser beam printer. In addition, the process cartridge 9 may be configured to accommodate a plurality of components in the components of the electrophotographic photosensitive member 1, the charging unit 2, the developing unit 4 and the cleaning unit 8, in a container, and to integrally support the plurality of components; and be configured to be freely attachable to and detachable from the main body of the electrophotographic apparatus. In FIG. 2, the process cartridge 9 is configured to integrally support the electrophotographic photosensitive member 1, the charging unit 2, the developing unit 4 and the cleaning unit 8, and to be detachably attachable to the main body of the electrophotographic apparatus.

Next, the electrophotographic apparatus will be described that includes the electrophotographic photosensitive member of the present disclosure. FIG. 3 illustrates one example of a configuration of the electrophotographic apparatus of the present disclosure. Process cartridges are juxtaposed along an intermediate transfer body 10, which are a process cartridge 17 for a yellow color, a process cartridge 18 for a magenta color, a process cartridge 19 for a cyan color, and a process cartridge 20 for a black color, which correspond to the respective colors of the yellow color, the magenta color, the cyan color and the black color. A diameter and a constituent material of the electrophotographic photosensitive member, a developer, a charging method and other units do not necessarily need to be unified for each color.

When the image forming operation starts, the toner images of the respective colors are sequentially superimposed on the intermediate transfer body 10, according to the above described image forming process. In parallel, a transfer paper 11 is fed from a paper feed tray 13 through a paper feeding path 12, and is fed to a secondary transfer unit 14, at the same timing as a rotation movement of the intermediate transfer body. A toner image on the intermediate transfer body 10 is transferred to the transfer paper 11 by a transfer bias applied from the secondary transfer unit 14. The toner image transferred onto the transfer paper 11 is conveyed along the paper feeding path 12, and is fixed onto the transfer paper by a fixing unit 15; and the resultant paper is ejected from a paper ejecting part 16.

### EXAMPLES

The present disclosure will be described in more detail below with reference to Examples and Comparative Examples, but the present disclosure is not limited thereto. Herein, “part(s)” in the description of the following Examples is based on mass unless otherwise specified.

<Synthesis of Polymer A>

The polymer Ain the present disclosure, which had the structural unit represented by the formula (1) and the structural unit represented by the formula (2), was synthesized in the following way. For information, a compound which were used in the following synthesis examples can be produced, for example, by referring to Japanese Patent Application Laid-Open No. 2009-104145.

(Polymer A1)

In a glass flask equipped with a stirrer, a reflux condenser, a nitrogen gas introduction pipe, a thermostatic chamber and a thermometer, 52 parts of a compound represented by the following formula (1-1), 100 parts of a compound represented by the following formula (2-1), 0.52 parts of 1,1′-azobis(1-acetoxy-1-phenylethane) (trade name: OT AZO-15, produced by Otsuka Chemical Co., Ltd.), and 338 parts of n-butyl acetate were mixed under a nitrogen atmosphere at 20° C. for 30 minutes, then the reaction liquid was heated so as to become 85 to 90° C., and was subjected to the reaction for 5 hours. The reaction was stopped by ice cooling, 1500 parts by mass of 2-propanol was added thereto, and a precipitate was obtained. The precipitate was cleaned by a mixed solvent of n-butyl acetate: 2-propanol=1:5, then the resultant precipitate was dried at a temperature of 80° C. in a state of a reduced pressure of 1325 Pa or less for 3 hours, and a polymer A1 was obtained.

(Polymer A2)

A polymer A2 was obtained in the same way as the polymer A1 except that in the synthesis of the polymer A1, 52 parts of the compound represented by the formula (1-1) was changed to 53 parts of a compound represented by the formula (1-2).

(Polymer A3)

A polymer A3 was obtained in the same way as the polymer A1 except that in the synthesis of the polymer A1, 52 parts of the compound represented by the formula (1-1) was changed to 50 parts of a compound represented by the formula (1-3).

(Polymer A4)

A polymer A4 was obtained in the same way as the polymer A1 except that in the synthesis of the polymer A1, 52 parts of the compound represented by the formula (1-1) was changed to 53 parts of a compound represented by the formula (1-4).

(Polymer A5)

A polymer A5 was obtained in the same way as the polymer A1 except that in the synthesis of the polymer A1, 100 parts of the compound represented by the formula (2-1) was changed to 45 parts of a compound represented by the formula (2-2).

(Polymer A6)

A polymer A6 was obtained in the same way as the polymer A1 except that in the synthesis of the polymer A1, 100 parts of the compound represented by the formula (2-1) was changed to 248 parts of a compound represented by the formula (2-3).

(Polymer A7)

A polymer A7 was obtained in the same way as the polymer A1 except that in the synthesis of the polymer A1, 52 parts of the compound represented by the formula (1-1) was changed to 52 parts of a compound represented by the formula (1-5).

(Polymer A8)

A polymer A8 was obtained in the same way as the polymer A1 except that in the synthesis of the polymer A1, 52 parts of the compound represented by the formula (1-1) was changed to 52 parts of a compound represented by the formula (1-6).

(Polymer A9)

A polymer A9 was obtained in the same way as the polymer A1 except that in the synthesis of the polymer A1, 52 parts of the compound represented by the formula (1-1) was changed to 52 parts of a compound represented by the formula (1-7).

(Polymer A10)

A polymer A10 was obtained in the same way as the polymer A1 except that in the synthesis of the polymer A1, 52 parts of the compound represented by the formula (1-1) was changed to 52 parts of a compound represented by the formula (1-8).

(Polymer A11)

A polymer A11 was obtained in the same way as the polymer A1 except that in the synthesis of the polymer A1, 52 parts of the compound represented by the formula (1-1) was changed to 47 parts of a compound represented by the formula (1-9).

(Polymer A12)

A polymer A12 was obtained in the same way as the polymer A1 except that in the synthesis of the polymer A1, 52 parts of the compound represented by the formula (1-1) was changed to 43 parts of a compound represented by the formula (1-10).

(Polymer A13)

A polymer A13 was obtained in the same way as the polymer A1 except that in the synthesis of the polymer A1, 52 parts of the compound represented by the formula (1-1) was changed to 52 parts of a compound represented by the formula (1-11).

(Polymer A14)

A polymer A14 was obtained in the same way as the polymer A1 except that in the synthesis of the polymer A1, 52 parts of the compound represented by the formula (1-1) was changed to 47 parts of a compound represented by the formula (1-12).

(Polymer A15)

A polymer A15 was obtained in the same way as the polymer A14 except that in the synthesis of the polymer A14, 100 parts of the compound represented by the formula (2-1) was changed to 45 parts of the compound represented by the formula (2-2).

(Polymer A16)

A polymer A16 was obtained in the same way as the polymer A14 except that in the synthesis of the polymer A14, 100 parts of the compound represented by the formula (2-1) was changed to 245 parts of the compound represented by the formula (2-3).

(Polymer A17)

A polymer A17 was obtained in the same way as the polymer A14 except that in the synthesis of the polymer A14, 47 parts of the compound represented by the formula (1-12) was changed to 50 parts of the compound represented by the formula (1-12), and 100 parts of the compound represented by the formula (2-1) was changed to 67 parts of the compound represented by the formula (2-1).

(Polymer A18)

A polymer A18 was obtained in the same way as the polymer A14 except that in the synthesis of the polymer A14, 47 parts of the compound represented by the formula (1-12) was changed to 39 parts of the compound represented by the formula (1-12), and 100 parts of the compound represented by the formula (2-1) was changed to 200 parts of the compound represented by the formula (2-1).

(Polymer A19)

A polymer A19 was obtained in the same way as the polymer A14 except that in the synthesis of polymer A14, 0.52 parts of the 1,1′-azobis(1-acetoxy-1-phenylethane) (trade name: OT AZO-15, produced by Otsuka Chemical Co., Ltd.) was changed to 0.98 parts of the 1,1′-azobis(1-acetoxy-1-phenylethane) (trade name: OT AZO-15, produced by Otsuka Chemical Co., Ltd.).

(Polymer A20)

A polymer A20 was obtained in the same way as the polymer A14 except that in the synthesis of polymer A14, 0.52 parts of the 1,1′-azobis(1-acetoxy-1-phenylethane) (trade name: OT AZO-15, produced by Otsuka Chemical Co., Ltd.) was changed to 0.16 parts of the 1,1′-azobis(1-acetoxy-1-phenylethane) (trade name: OT AZO-15, produced by Otsuka Chemical Co., Ltd.).

(Polymer A21)

A polymer A21 was obtained in the same way as the polymer A1 except that in the synthesis of the polymer A1, 52 parts of the compound represented by the formula (1-1) was changed to 47 parts of a compound represented by the formula (1-13).

(Polymer A22)

A polymer A22 was obtained in the same way as the polymer A1 except that in the synthesis of the polymer A1, 52 parts of the compound represented by the formula (1-1) was changed to 43 parts of a compound represented by the formula (1-14).

(Polymer A23)

A polymer A23 was obtained in the same way as the polymer A1 except that in the synthesis of the polymer A1, 52 parts of the compound represented by the formula (1-1) was changed to 39 parts of a compound represented by the formula (1-15).

(Polymer A24)

A polymer A24 was obtained in the same way as the polymer A1 except that in the synthesis of the polymer A1, 52 parts of the compound represented by the formula (1-1) was changed to 39 parts of a compound represented by the formula (1-16).

(Polymer A25)

A polymer A25 was obtained in the same way as the polymer A1 except that in the synthesis of the polymer A1, 52 parts of the compound represented by the formula (1-1) was changed to 39 parts of a compound represented by the formula (1-17).

(Polymer A26)

A polymer A26 was obtained in the same way as the polymer A1 except that in the synthesis of the polymer A1, 52 parts of the compound represented by the formula (1-1) was changed to 26 parts of a compound represented by the formula (1-18).

(Polymer A27)

A polymer A27 was obtained in the same way as the polymer A14 except that in the synthesis of the polymer A14, 44 parts of the compound represented by the formula (1-12) was changed to 53 parts of the compound represented by the formula (1-12), and 100 parts of the compound represented by the formula (2-1) was changed to 33 parts of the compound represented by the formula (2-1).

(Polymer A28)

A polymer A28 was obtained in the same way as the polymer A14 except that in the synthesis of the polymer A14, 44 parts of the compound represented by the formula (1-12) was changed to 28 parts of the compound represented by the formula (1-12), and 100 parts of the compound represented by the formula (2-1) was changed to 333 parts of the compound represented by the formula (2-1).

(Polymer A29)

A polymer A29 was obtained in the same way as the polymer A1 except that in the synthesis of the polymer A1, 52 parts of the compound represented by the formula (1-1) was changed to 56 parts of a compound represented by the formula (1-19).

(Polymer A30)

A polymer A30 was obtained in the same way as the polymer A1 except that in the synthesis of the polymer A1, 52 parts of the compound represented by the formula (1-1) was changed to 52 parts of a compound represented by the formula (1-20).

(Polymer A31)

A polymer A31 was obtained in the same way as the polymer A1 except that in the synthesis of the polymer A1, 52 parts of the compound represented by the formula (1-1) was changed to 53 parts of a compound represented by the formula (1-21).

(Polymer A32)

A polymer A32 was obtained in the same way as the polymer A1 except that in the synthesis of the polymer A1, 100 parts of the compound represented by the formula (2-1) was changed to 28 parts of a compound represented by the formula (2-4).

(Polymer A33)

A polymer A33 was obtained in the same way as the polymer A1 except that in the synthesis of the polymer A1, 100 parts of the compound represented by the formula (2-1) was changed to 296 parts of a compound represented by the formula (2-5).

(Polymer A34)

A polymer A34 was obtained in the same way as the polymer A14 except that in the synthesis of the polymer A14, 100 parts of the compound represented by the formula (2-1) was changed to 28 parts of the compound represented by the formula (2-4).

(Polymer A35)

A polymer A35 was obtained in the same way as the polymer A14 except that in the synthesis of the polymer A14, 100 parts of the compound represented by the formula (2-1) was changed to 292 parts of the compound represented by the formula (2-3).

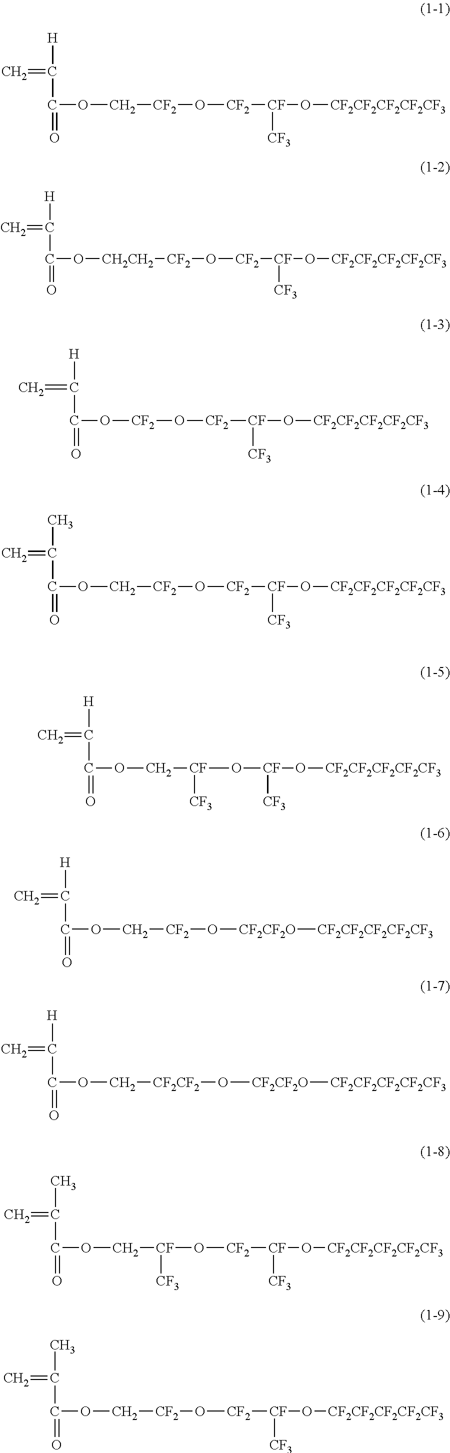

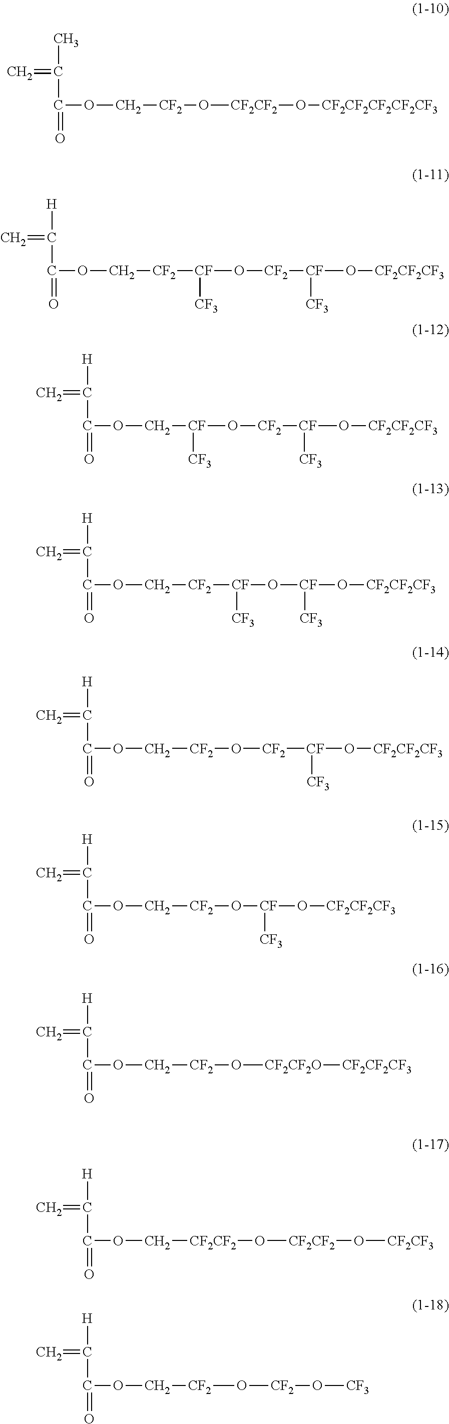

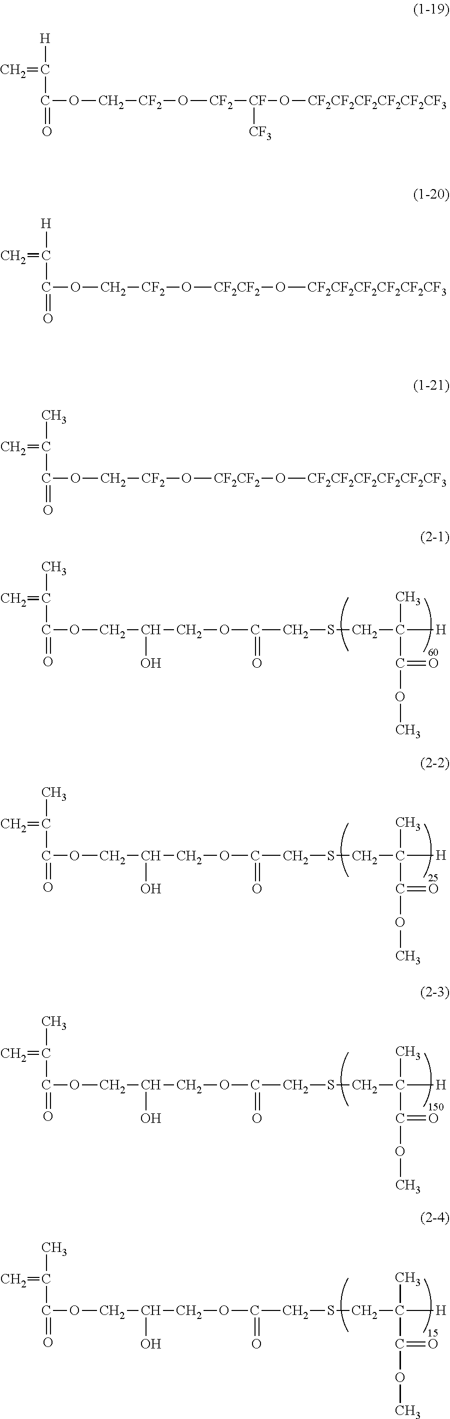

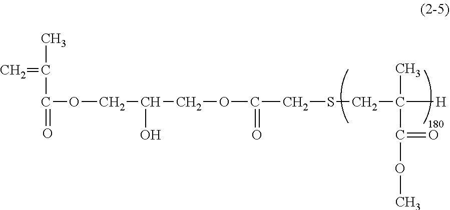

The obtained polymers A1 to A35 were subjected to GPC measurement by the previously described method, and the respective weight average molecular weights were calculated. The results are shown in Table 3.

TABLE 3

| | Structural unit represented by formula (1) | | | | | | | Result of |
|---|---|---|---|---|---|---|---|---|
| | | | | | | Sum | Number | GPC |
| Num- | | | | | | of the | of | measure- |
| ber | | | | | | number | structural | ment |
| of | | | | | | of carbon | unit | Weight |
| poly- | | | | | | atoms of | represented | average |
| mer | | | | | | Rf¹1 to | by formula | molecular |
| A | R¹^{¹} | R^{¹}² | Rf¹¹ | Rf¹² | Rf¹³ | Rf¹³ | (2) | weight |
| A1 | —H | —CH₂— | —CF₂— | 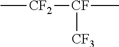 | —CF₂—CF₂—CF₂—CF₂—CF₃ | 9 | (2-1′) | 33456 |
| A2 | —H | —CH₂—CH₂— | —CF₂— | 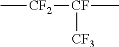 | —CF₂—CF₂—CF₂—CF₂—CF₃ | 9 | (2-1′) | 33562 |
| A3 | —H | Single bond | —CF₂— | 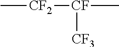 | —CF₂—CF₂—CF₂—CF₂—CF₃ | 9 | (2-1′) | 33122 |
| A4 | —CH₃ | —CH₂— | —CF₂— | 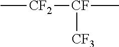 | —CF₂—CF₂—CF₂—CF₂—CF₃ | 9 | (2-1′) | 34587 |
| A5 | —H | —CH₂— | —CF₂— | 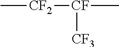 | —CF₂—CF₂—CF₂—CF₂—CF₃ | 9 | (2-2′) | 21050 |
| A6 | —H | —CH₂— | —CF₂— | 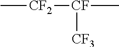 | —CF₂—CF₂—CF₂—CF₂—CF₃ | 9 | (2-3′) | 65025 |
| A7 | —H | —CH₂— | 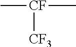 | 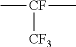 | —CF₂—CF₂—CF₂—CF₂—CF₃ | 9 | (2-1′) | 33368 |
| A8 | —H | —CH₂— | —CF₂— | —CF₂—CF₂— | —CF₂—CF₂—CF₂—CF₂—CF₃ | 8 | (2-1′) | 32878 |
| A9 | —H | —CH₂— | —CF₂—CF₂— | —CF₂—CF₂— | —CF₂—CF₂—CF₂—CF₂—CF₃ | 9 | (2-1′) | 34110 |
| A10 | —H | —CH₂— | 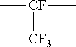 | 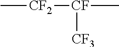 | —CF₂—CF₂—CF₂—CF₃ | 9 | (2-1′) | 33325 |
| A11 | —H | —CH₂— | —CF₂— | 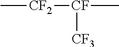 | —CF₂—CF₂—CF₂—CF₃ | 8 | (2-1′) | 32125 |
| A12 | —H | —CH₂— | —CF₂— | —CF₂—CF₂— | —CF₂—CF₂—CF₂—CF₃ | 7 | (2-1′) | 30972 |
| A13 | —H | —CH₂— | 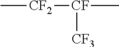 | 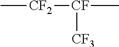 | —CF₂—CF₂—CF₃ | 9 | (2-1′) | 33367 |
| A14 | —H | —CH₂— | 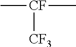 | 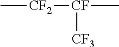 | —CF₂—CF₂—CF₃ | 8 | (2-1′) | 32340 |
| A15 | —H | —CH₂— | 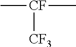 | 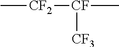 | —CF₂—CF₂—CF₃ | 8 | (2-2′) | 20300 |
| A16 | —H | —CH₂— | 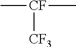 | 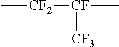 | —CF₂—CF₂—CF₃ | 8 | (2-3′) | 63809 |
| A17 | —H | —CH₂— | 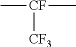 | 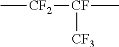 | —CF₂—CF₂—CF₃ | 8 | (2-1′) | 25351 |
| A18 | —H | —CH₂— | 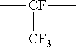 | 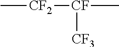 | —CF₂—CF₂—CF₃ | 8 | (2-1′) | 51924 |
| A19 | —H | —CH₂— | 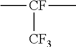 | 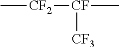 | —CF₂—CF₂—CF₃ | 8 | (2-1′) | 99752 |
| A20 | —H | —CH₂— | 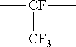 | 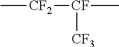 | —CF₂—CF₂—CF₃ | 8 | (2-1′) | 16222 |
| A21 | —H | —CH₂— | 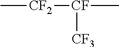 | | —CF₂—CF₂—CF₃ | 8 | (2-1′) | 32126 |
| A22 | —H | —CH₂— | —CF₂— | 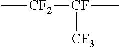 | —CF₂—CF₂—CF₃ | 7 | (2-1′) | 31663 |
| A23 | —H | —CH₂— | —CF₂— | 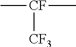 | —CF₂—CF₂—CF₃ | 6 | (2-1′) | 29947 |
| A24 | —H | —CH₂— | —CF₂— | —CF₂—CF₂— | —CF₂—CF₂—CF₃ | 6 | (2-1′) | 29867 |
| A25 | —H | —CH₂— | —CF₂—CF₂— | —CF₂—CF₂— | —CF₂—CF₃ | 6 | (2-1′) | 28958 |
| A26 | —H | —CH₂— | —CF₂— | —CF₂— | —CF₃ | 3 | (2-1′) | 26867 |
| A27 | —H | —CH₂— | 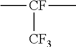 | 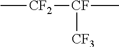 | —CF₂—CF₂—CF₃ | 8 | (2-1′) | 18714 |
| A28 | —H | —CH₂— | 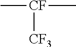 | 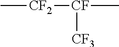 | —CF₂—CF₂—CF₃ | 8 | (2-1′) | 78491 |
| A29 | —H | —CH₂— | —CF₂— | 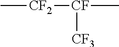 | —CF₂—CF₂—CF₂—CF₂—CF₂—CF₃ | 10 | (2-1′) | 34052 |
| A30 | —H | —CH₂— | —CF₂— | —CF₂—CF₂— | —CF₂—CF₂—CF₂—CF₂—CF₂—CF₃ | 9 | (2-1′) | 33567 |
| A31 | —CH₃ | —CH₂— | —CF₂— | —CF₂—CF₂— | —CF₂—CF₂—CF₂—CF₂—CF₂—CF₃ | 9 | (2-1′) | 33212 |
| A32 | —H | —CH₂— | —CF₂— | 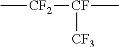 | —CF₂—CF₂—CF₂—CF₂—CF₃ | 9 | (2-4′) | 17449 |
| A33 | —H | —CH₂— | —CF₂— | 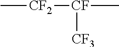 | —CF₂—CF₂—CF₂—CF₂—CF₃ | 9 | (2-5′) | 75231 |
| A34 | —H | —CH₂— | 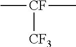 | 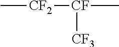 | —CF₂—CF₂—CF₃ | 8 | (2-4′) | 16422 |
| A35 | —H | —CH₂— | 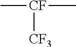 | 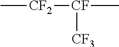 | —CF₂—CF₂—CF₃ | 8 | (2-5′) | 74380 |

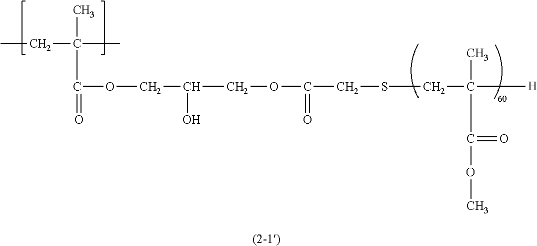

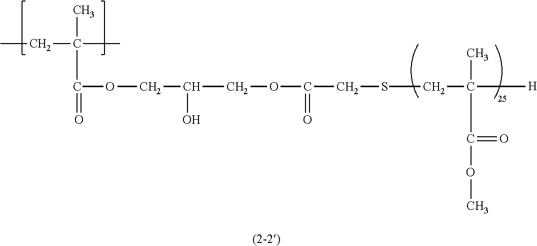

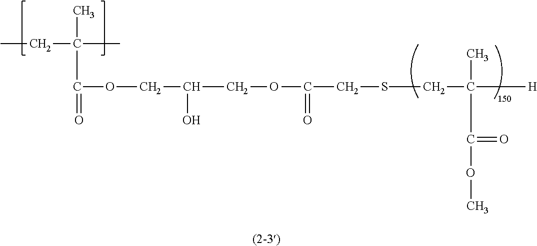

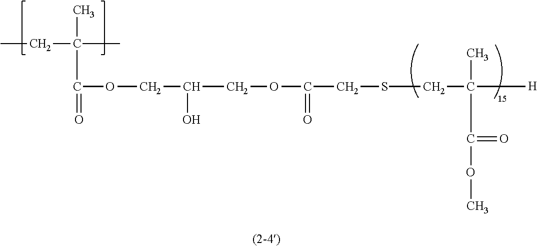

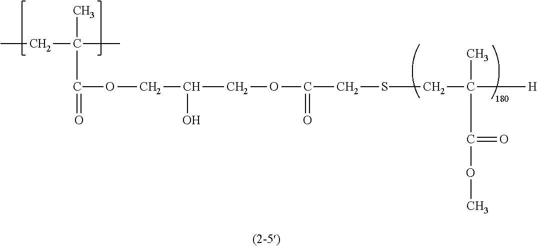

<Production of Electrophotographic Photosensitive Member>

### Example 1

(Support)

A cylindrical aluminum cylinder (JIS-A3003, aluminum alloy, having outer diameter of 30 mm, length of 357.5 mm and thickness of 0.7 mm) was subjected to cutting work and the resultant cylinder was used as a support (electroconductive support). Ultrasonic cleaning in a cleaning liquid containing a detergent (trade name: Chemicol CT, produced by Tokiwa Chemical Industries Co., Ltd.) dissolved in pure water was performed, and then the cleaning liquid was washed away; and further ultrasonic cleaning in pure water was performed and degreasing treatment was performed, to obtain a support.

(Undercoat Layer)

Sixty parts of a zinc oxide particle (average particle size: 70 nm, and specific surface area: 15 m²/g) was mixed with 500 parts of tetrahydrofuran while being stirred; and to this mixture, 0.75 parts of a silane coupling agent (compound name: N-2-(aminoethyl)-3-aminopropyltrimethoxy silane, and trade name: KBM603, produced by Shin-Etsu Chemical Co., Ltd.) was added, and the mixture was stirred for 2 hours. After that, tetrahydrofuran was distilled off under reduced pressure, and the resultant was heated and dried at 120° C. for 3 hours; and a surface-treated zinc oxide particle was obtained.

Subsequently, 25 parts of butyral (trade name: BM-1, produced by Sekisui Chemical Co., Ltd.) as a polyol, and 22.5 parts of a blocked isocyanate (trade name: Sumidule BL-3173, produced by Sumika Covestro Urethane Co., Ltd.) were dissolved in 142 parts of methyl ethyl ketone. To this solution, 100 parts of the surface-treated zinc oxide particle and 1 part of anthraquinone were added, and the resultant was dispersed in a sand mill with the use of glass beads having a diameter of 1 mm for 5 hours.

After the dispersion treatment, 0.008 parts of dioctyl tin dilaurate and 6.5 parts of a silicone resin particle (Tospearl 145, produced by GE Toshiba Silicone Co., Ltd.) were added to the above mixture, and the resultant mixture was stirred; and a coating liquid for an undercoat layer was prepared.

The support was dip-coated with the obtained coating liquid for the undercoat layer to have a coating film formed thereon, the coating film was dried at 190° C. for 24 minutes, and an undercoat layer was formed which had a film thickness of 20 μm.

(Charge Generation Layer)

Next, 15 parts of a chlorogallium phthalocyanine crystal having strong diffraction peaks at least at 7.4°, 16.6°, 25.5° and 28.3° at a Bragg angle (2θ±0.2°) in CuKα characteristic X-rays, 10 parts of a vinyl chloride-vinyl acetate copolymer resin (VMCH, produced by Nippon Union Carbide), and 300 parts of n-butyl alcohol are mixed; and the mixture was subjected to dispersion treatment in a sand mill which used glass beads having a diameter of 1 mm, for 4 hours; and a coating liquid for a charge generation layer was prepared.

The undercoat layer was dip-coated with the coating liquid for the charge generation layer, and the obtained coating film was dried at 150° C. for 5 minutes; and thereby, a charge generation layer was formed which had a film thickness of 0.2 μm.

(Charge Transport Layer)

Next, 10 parts of a polytetrafluoroethylene resin particle (average size of primary particles of 210 nm, and average circularity of 0.85), 0.55 parts of the previously described polymer A1 and 50 parts of tetrahydrofuran were mixed while the mixture was stirred and the liquid temperature was kept at 20° C., for 48 hours, and a preparation liquid A was obtained.

Next, 40 parts of N,N′-bis(3-methylphenyl)-N,N′-diphenylbenzidine, 10 parts of a compound represented by the following formula (3-1), 75 parts of a bisphenol Z type polycarbonate resin (viscosity average molecular weight of 40,000) and 2.0 parts of 2,6-di-t-butyl-4-methylphenol serving as an antioxidizing agent were mixed, and the mixture was mixed with and dissolved into 250 parts of tetrahydrofuran; and a preparation liquid B was obtained.

The preparation liquid A was added to the preparation liquid B, and the mixture was stirred and mixed, and was passed through a high-pressure dispersing machine (trade name: Microfluidizer M-110EH, manufactured by Microfluidics Co., Ltd. U.S.); and a dispersion liquid was obtained.

After that, a coating liquid for the charge transport layer was prepared by adding a fluorine-modified silicone oil (trade name: FL-100 Shin-Etsu Chemical Co., Ltd.) to the dispersion liquid so that the concentration was 5 ppm, and filtering the mixture through the polyflon filter (trade name: PF-040, manufactured by Advantec Toyo Kaisha, Ltd.).

The charge generation layer was dip-coated with this coating liquid for the charge transport layer to have a coating film formed thereon, and the obtained coating film was dried at 150° C. for 40 minutes; and a charge transport layer was formed which had a film thickness of 40 μm.

In this way, the electrophotographic photosensitive member of Example 1 was produced.

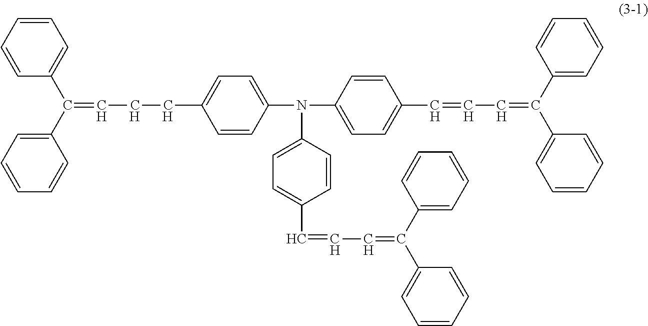 [SMILES: C(=Cc1ccc(N(c2ccc(C=CC=C(c3ccccc3)c3ccccc3)cc2)c2ccc(CCC=C(c3ccccc3)c3ccccc3)cc2)cc1)C=C(c1ccccc1)c1ccccc1]

### Examples 2 to 40, Comparative Examples 1 to 10, Reference Examples 1 to 3

Electrophotographic photosensitive members of Examples 2 to 40, Comparative Examples 1 to 10 and Reference Examples 1 to 3 were produced in the same way as in Example 1, except that when the charge transport layer was formed, the type of the polymer A, the amount of the polymer A to be added, the type of the polytetrafluoroethylene resin particle, and a film thickness of the layer were changed as shown in Table 4.

TABLE 4

| | | | Average primary | Average | |
|---|---|---|---|---|---|
| | | Amount of | particle size of | circularity of | Film |
| | | added | polytetra- | polytetra- | thickness of |
| | Number of | polymer A | fluoroethylene | fluoroethylene | surface layer |
| | polymer A | [parts] | particles [nm] | particles | [μm] |
| Example 1 | A1 | 0.55 | 210 | 0.85 | 40 |
| Example 2 | A2 | 0.55 | 210 | 0.85 | 40 |
| Example 3 | A3 | 0.55 | 210 | 0.85 | 40 |
| Example 4 | A4 | 0.55 | 210 | 0.85 | 40 |
| Example 5 | A5 | 0.55 | 210 | 0.85 | 40 |
| Example 6 | A6 | 0.55 | 210 | 0.85 | 40 |
| Example 7 | A7 | 0.55 | 210 | 0.85 | 40 |
| Example 8 | A8 | 0.55 | 210 | 0.85 | 40 |
| Example 9 | A9 | 0.55 | 210 | 0.85 | 40 |
| Example 10 | A10 | 0.55 | 210 | 0.85 | 40 |
| Example 11 | A11 | 0.55 | 210 | 0.85 | 40 |
| Example 12 | A12 | 0.55 | 210 | 0.85 | 40 |
| Example 13 | A13 | 0.55 | 210 | 0.85 | 40 |
| Example 14 | A14 | 0.55 | 210 | 0.85 | 40 |
| Example 15 | A15 | 0.55 | 210 | 0.85 | 40 |
| Example 16 | A16 | 0.55 | 210 | 0.85 | 40 |
| Example 17 | A17 | 0.55 | 210 | 0.85 | 40 |
| Example 18 | A18 | 0.55 | 210 | 0.85 | 40 |
| Example 19 | A19 | 0.55 | 210 | 0.85 | 40 |
| Example 20 | A20 | 0.55 | 210 | 0.85 | 40 |
| Example 21 | A21 | 0.55 | 210 | 0.85 | 40 |
| Example 22 | A22 | 0.55 | 210 | 0.85 | 40 |
| Example 23 | A23 | 0.55 | 210 | 0.85 | 40 |
| Example 24 | A24 | 0.55 | 210 | 0.85 | 40 |
| Example 25 | A25 | 0.55 | 210 | 0.85 | 40 |
| Example 26 | A26 | 0.55 | 210 | 0.85 | 40 |
| Example 27 | A27 | 0.55 | 210 | 0.85 | 40 |
| Example 28 | A28 | 0.55 | 210 | 0.85 | 40 |
| Example 29 | A14 | 0.20 | 210 | 0.85 | 40 |
| Example 30 | A14 | 1.00 | 210 | 0.85 | 40 |
| Example 31 | A14 | 0.40 | 210 | 0.85 | 40 |
| Example 32 | A14 | 0.80 | 210 | 0.85 | 40 |
| Example 33 | A14 | 0.55 | 189 | 0.87 | 40 |
| Example 34 | A14 | 0.55 | 247 | 0.80 | 40 |
| Example 35 | A14 | 0.55 | 152 | 0.85 | 40 |
| Example 36 | A14 | 0.55 | 348 | 0.79 | 40 |
| Example 37 | A1 | 0.55 | 210 | 0.85 | 35 |
| Example 38 | A1 | 0.55 | 210 | 0.85 | 50 |
| Example 39 | A14 | 0.55 | 210 | 0.85 | 35 |
| Example 40 | A14 | 0.55 | 210 | 0.85 | 50 |
| Comparative | A29 | 0.55 | 210 | 0.85 | 40 |
| Example 1 | | | | | |
| Comparative | A30 | 0.55 | 210 | 0.85 | 40 |
| Example 2 | | | | | |
| Comparative | A31 | 0.55 | 210 | 0.85 | 40 |
| Example 3 | | | | | |
| Comparative | A32 | 0.55 | 210 | 0.85 | 40 |
| Example 4 | | | | | |
| Comparative | A33 | 0.55 | 210 | 0.85 | 40 |
| Example 5 | | | | | |
| Comparative | A34 | 0.55 | 210 | 0.85 | 40 |
| Example 6 | | | | | |
| Comparative | A35 | 0.55 | 210 | 0.85 | 40 |
| Example 7 | | | | | |
| Comparative | A29 | 0.55 | 210 | 0.85 | 35 |
| Example 8 | | | | | |
| Comparative | A1 | 0.55 | 210 | 0.85 | 55 |
| Example 9 | | | | | |
| Comparative | A14 | 0.55 | 210 | 0.85 | 55 |
| Example 10 | | | | | |
| Reference | A29 | 0.55 | 210 | 0.85 | 30 |
| Example 1 | | | | | |
| Reference | A32 | 0.55 | 210 | 0.85 | 30 |
| Example 2 | | | | | |
| Reference | A33 | 0.55 | 210 | 0.85 | 30 |
| Example 3 | | | | | |

<Evaluation of Electrophotographic Photosensitive Member>

The electrophotographic photosensitive members produced in the Examples 1 to 40, Comparative Examples 1 to 10 and Reference Examples 1 to 3 were evaluated in the following way.

[Evaluation Apparatus 1-1]

The electrophotographic photosensitive members produced in Examples 1 to 40, Comparative Examples 1 to 10 and Reference Examples 1 to 3 were each mounted on an image RUNNER ADVANCE DX C3835F (trade name), which was a copying machine manufactured by Canon Inc., and were each evaluated.

Specifically, the above evaluation apparatus was installed in an ordinary-temperature and ordinary-humidity environment of a temperature of 23° C. and a relative humidity of 50% RH; the produced electrophotographic photosensitive member was mounted in a process cartridge for a magenta color; the resultant process cartridge was mounted in a station for the process cartridge for magenta; and the electrophotographic photosensitive member was evaluated.

[Evaluation Apparatus 1-2]

The electrophotographic photosensitive members produced in Examples 1 to 40 and Comparative Examples 1 to 10 and Reference Examples 1 to 3 were mounted on a modified machine (of which the charging unit had a system of applying a DC voltage to a roller type of a contact charging member (charging roller), and the exposure unit had a laser image exposure system (wavelength of 780 nm)) of an image RUNNER ADVANCE DX C3835F (trade name), which was a copying machine manufactured by Canon Inc., and were evaluated. Specifically, the above evaluation apparatus was installed in an ordinary-temperature and ordinary-humidity environment of a temperature of 23° C. and a relative humidity of 50% RH; the produced electrophotographic photosensitive member was mounted in a process cartridge for a magenta color; the resultant process cartridge was mounted in a station for the process cartridge for magenta; and the electrophotographic photosensitive member was evaluated.

For information, a surface potential of the electrophotographic photosensitive member was measured by taking out a developing cartridge from the above evaluation apparatus, and inserting a potential measuring apparatus into the developing cartridge. The potential measuring apparatus was configured in such a way that a potential measuring probe (trade name: model 6000B-8, manufactured by TREK Japan) was arranged at a developing position of the developing cartridge; and a position of the potential measuring probe with respect to the electrophotographic photosensitive member was set at the center of the electrophotographic photosensitive member in the generatrix direction and at such a position that the gap from the surface of the electrophotographic photosensitive member became 3 mm. Furthermore, the potential of the central portion of the electrophotographic photosensitive member was measured with the use of a surface electrometer (trade name: model 344, manufactured by TREK Japan).

(Evaluation of Initial Image)

The image was evaluated with the use of the above evaluation apparatus 1-1. With the use of A4-size gloss paper, a solid white image on the whole surface was output, and the number of image defects caused by a dispersion defect, specifically, black spots was visually evaluated according to the following evaluation rank, which were included in the area in the output image, which corresponded to one circumferential length of the electrophotographic photosensitive member. For information, the area corresponding to one circumferential length of the electrophotographic photosensitive member is a rectangular area having a length of 297 mm that is the long side length of the A4 sheet and a width of 94.2 mm that is one circumferential length of the electrophotographic photosensitive member. In addition, in the present disclosure, it has been determined that ranks A, B, C and D are levels at which the effect of the present disclosure is obtained, and among the ranks, the rank A is an excellent level. On the other hand, rank E has been determined to be a level at which the effect of the present disclosure is not obtained.

A: There is no black spot.

B: There are 1 or more and 3 or less black spots having a diameter smaller than 1.5 mm, and no black spot having a diameter of 1.5 mm or larger.

C: There are 1 or more and 3 or less black spots having the diameter smaller than 1.5 mm, and 1 or more and 2 or less black spots having the diameter of 1.5 mm or larger.

D: There are 4 or more and 5 or less black spots having the diameter smaller than 1.5 mm, and 2 or less black spots having the diameter of 1.5 mm or larger.

E: There are 6 or more black spots having the diameter smaller than 1.5 mm, and 3 or more black spots having the diameter of 1.5 mm or larger.

The evaluation results obtained in this way are shown in Table 4.

(Evaluation of Ghost)

The ghost was evaluated by repeatedly outputting images with the use of the above evaluation apparatus 1-1 as in the following way, and then measuring a ghost potential with the use of the above evaluation apparatus 1-2. A cartridge equipped with the electrophotographic photosensitive member was attached to the evaluation apparatus 1-1, and a monochromatic character image with a print rate of 1% was repeatedly formed on 20,000 sheets of plain paper having an A4 size. Next, the electrophotographic photosensitive member which was repeatedly used was attached to the cartridge and the resultant cartridge was mounted in the evaluation apparatus 1-2. The ghost potential was measured by inputting a signal which outputs an image illustrated in FIG. 4, to the evaluation apparatus 1-2. FIG. 4 illustrates an output image, and illustrates a ghost 402 which has occurred in a one-dot knight pattern image 401, and a solid patch 404 in a white image 403. In the evaluation apparatus 1-2, the previously described potential measuring probe was fixed so as to be positioned at the position of the solid patch 404 in the signal which output the image illustrated in FIG. 4. An applied bias was set so that the potential of the dark portion of the non-exposed portion of the electrophotographic photosensitive member became −500 V, and the light quantity of the laser light was set so as to become 0.30 ρJ/cm². An electrostatic latent image corresponding to the image illustrated in FIG. 4 is formed on the surface of the photosensitive member, by the signal which outputs the image illustrated in FIG. 4. In the electrostatic latent image corresponding to the image illustrated in FIG. 4, the ghost potential was defined to be a potential difference between a potential in region at which a ghost image occurred in a region in which the half-tone image was formed and a potential in a region other than the region at which the ghost image occurred in the region at which the half-tone image was formed. In Example 1, the ghost potential after repeated use of 20,000 sheets was 7 V

In the present disclosure, the smaller the ghost potential, the better, and the effect of the present disclosure is obtained.

The evaluation results obtained in this way are shown in Table 4.

(Evaluation of Durability)

The durability was evaluated with the use of the above evaluation apparatus 1-1.

A cartridge equipped with the electrophotographic photosensitive member was attached to the evaluation apparatus, and a character image having a print rate of 1% was repeatedly formed on plain paper of an A4 size, with a single color for which the electrophotographic photosensitive member was installed. While the image is repeatedly formed, the image and the film thickness of the surface layer of the electrophotographic photosensitive member were appropriately confirmed, and the number of sheets was confirmed that passed before the film thickness reached the minimum thickness at which a satisfactory image could be surely output.

In the present disclosure, the greater the number of the passed sheets, the better, and the effect of the present disclosure is obtained.

The evaluation results obtained in this way are shown in Table 5.

TABLE 5

| | | Ghost | Durability |
|---|---|---|---|
| | | evaluation | evaluation |
| | | Ghost | Number of |
| Number of | Initial | potential | passed sheets |
| Example | image | [V] | [sheets] |
| Example 1 | A | 7 | 90000 |
| Example 2 | B | 9 | 90000 |
| Example 3 | B | 9 | 90000 |
| Example 4 | A | 7 | 90000 |
| Example 5 | B | 9 | 90000 |
| Example 6 | B | 9 | 90000 |
| Example 7 | A | 7 | 90000 |
| Example 8 | A | 7 | 90000 |
| Example 9 | A | 7 | 90000 |
| Example 10 | A | 6 | 90000 |
| Example 11 | A | 6 | 90000 |
| Example 12 | A | 6 | 90000 |
| Example 13 | A | 5 | 90000 |
| Example 14 | A | 5 | 90000 |
| Example 15 | B | 7 | 90000 |
| Example 16 | B | 8 | 90000 |
| Example 17 | B | 7 | 90000 |
| Example 18 | B | 7 | 90000 |
| Example 19 | C | 5 | 90000 |
| Example 20 | C | 5 | 90000 |
| Example 21 | A | 5 | 90000 |
| Example 22 | A | 5 | 90000 |
| Example 23 | A | 5 | 90000 |
| Example 24 | A | 5 | 90000 |
| Example 25 | B | 7 | 90000 |
| Example 26 | D | 8 | 90000 |
| Example 27 | B | 8 | 90000 |
| Example 28 | B | 8 | 90000 |
| Example 29 | C | 8 | 90000 |
| Example 30 | C | 8 | 90000 |
| Example 31 | C | 8 | 90000 |
| Example 32 | C | 8 | 90000 |
| Example 33 | B | 5 | 90000 |
| Example 34 | B | 5 | 90000 |
| Example 35 | B | 5 | 90000 |
| Example 36 | B | 5 | 90000 |
| Example 37 | A | 5 | 75000 |
| Example 38 | A | 9 | 100000 |
| Example 39 | A | 4 | 75000 |
| Example 40 | A | 9 | 100000 |
| Comparative | C | 20 | 90000 |
| Example 1 | | | |
| Comparative | A | 20 | 90000 |
| Example 2 | | | |
| Comparative | A | 20 | 90000 |
| Example 3 | | | |
| Comparative | C | 19 | 90000 |
| Example 4 | | | |
| Comparative | D | 19 | 90000 |
| Example 5 | | | |
| Comparative | C | 19 | 90000 |
| Example 6 | | | |
| Comparative | E | 19 | 90000 |
| Example 7 | | | |
| Comparative | A | 17 | 75000 |
| Example 8 | | | |
| Comparative | A | 20 | 110000 |
| Example 9 | | | |
| Comparative | A | 18 | 110000 |
| Example 10 | | | |
| Reference | C | 7 | 60000 |
| Example 1 | | | |
| Reference | B | 6 | 60000 |
| Example 2 | | | |
| Reference | C | 6 | 60000 |
| Example 3 | | | |

According to one aspect of the present disclosure, there can be provided an electrophotographic photosensitive member having excellent dispersibility of fluorine atom-containing resin particles in the surface layer, and excellent durability, with suppressed ghost.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-020570, filed Feb. 14, 2022, which is hereby incorporated by reference herein in its entirety.

What is claimed is:

1. An electrophotographic photosensitive member comprising a surface layer, wherein
the surface layer comprises:
a fluorine atom-containing resin particle;
a binder material;
a charge transport substance; and
a polymer A having a structural unit represented by the following formula (1) and a structural unit represented by the following formula (2), wherein
the binder material is a thermoplastic resin, and
a film thickness of the surface layer is 35 μm or larger and 50 μm or smaller, 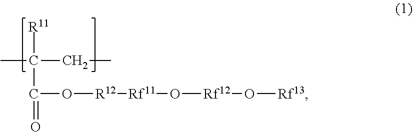
wherein
R¹¹ represents a hydrogen atom or a methyl group,
R¹² represents an ethylene group, a methylene group or a single bond,
Rf¹¹ and Rf¹² each independently represent a perfluoroalkylene group having 1 or more and 5 or less carbon atoms, or a perfluoroalkylidene group having 1 or more and 5 or less carbon atoms, and
R^{f13} represents a perfluoroalkyl group having 1 or more and 5 or less carbon atoms; and 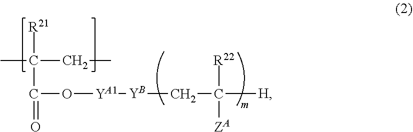
wherein
Y^{A1} represents an unsubstituted alkylene group,
Y^{B} represents an unsubstituted alkylene group, an alkylene group substituted with a halogen atom, an alkylene group substituted with a hydroxy group, an ester bond (—COO—), an amide bond (—NHCO—) or a urethane bond (—NHCOO—), or alternatively a divalent linking group that can be derived from a combination of one or more selected from the above groups and bonds, and —O— or —S—, or alternatively a single bond,
Z^{A} represents a structure represented by the following formula (2A), a cyano group or a phenyl group,
R²¹ and R²² each independently represent a hydrogen atom or a methyl group, and
m is an integer of 25 or larger and 150 or smaller, 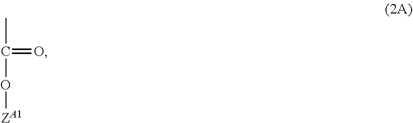
wherein Z^{A1} represents an alkyl group having 1 or more and 4 or less carbon atoms.

2. The electrophotographic photosensitive member according to claim 1, wherein
a structure represented by —Y^{A1}-Y^{B}— in the structural unit represented by the formula (2) is a structure represented by —Y^{A1}-Y^{A2})_{b}-(Y^{A3})_{c}-(Y^{A4})_{d}-(Y^{A5})ₑ-(Y^{A6})_{f}—, wherein
Y^{A1} represents an unsubstituted alkylene group,
Y^{A2} represents a methylene group substituted with at least one selected from the group consisting of a hydroxy group and a halogen atom,
Y^{A3} represents an unsubstituted alkylene group,
Y^{A4} represents an ester bond, an amide bond or a urethane bond,
Y^{A5} represents an unsubstituted alkylene group,
Y^{A6} represents an oxygen atom or a sulfur atom, and
b, c, d, e and f each independently represent 0 or 1.

3. The electrophotographic photosensitive member according to claim 1, wherein a content of the polymer A in the surface layer is 2% by mass or more and 10% by mass or less, with respect to a content of the fluorine atom-containing resin particle in the surface layer.

4. The electrophotographic photosensitive member according to claim 1, wherein a content of the polymer A in the surface layer is 4% by mass or more and 8% by mass or less, with respect to a content of the fluorine atom-containing resin particle in the surface layer.

5. The electrophotographic photosensitive member according to claim 1, wherein a content of the fluorine atom-containing resin particle in the surface layer is 5% by mass or more and 40% by mass or less, with respect to a total mass of the surface layer.

6. The electrophotographic photosensitive member according to claim 1, wherein a content of the fluorine atom-containing resin particle in the surface layer is 5% by mass or more and 15% by mass or less, with respect to a total mass of the surface layer.

7. The electrophotographic photosensitive member according to claim 1, wherein the thermoplastic resin is a polycarbonate resin.

8. The electrophotographic photosensitive member according to claim 1, wherein
the surface layer contains a compound represented by the following formula (3) as the charge transport substance: 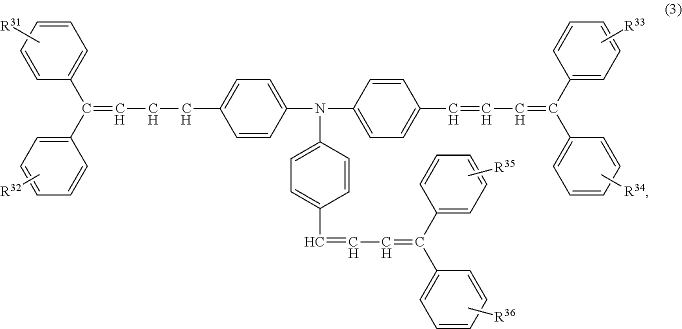
wherein R³¹, R³², R³³, R³⁴, R³⁵ and R³⁶ each independently represent a hydrogen atom, a methyl group or a methoxy group.

9. The electrophotographic photosensitive member according to claim 1, wherein R¹² in the structural unit represented by the formula (1) is a methylene group.

10. The electrophotographic photosensitive member according to claim 1, wherein R^{f11} and R^{f12} in the structural unit represented by the formula (1) are each independently a perfluoroalkylene group having 1 or more and 3 or less carbon atoms or a perfluoroalkylidene group having 1 or more and 3 or less carbon atoms, and Rf¹³ is a perfluoroalkyl group having 1 or more and 3 or less carbon atoms.

11. A process cartridge that integrally supports the electrophotographic photosensitive member comprising a surface layer, and at least one unit selected from the group consisting of a charging unit, a developing unit, a transfer unit, a static elimination unit and a cleaning unit, and that is detachably attachable to a main body of an electrophotographic apparatus, wherein
the surface layer comprises:
a fluorine atom-containing resin particle;
a binder material;
a charge transport substance; and
a polymer A having a structural unit represented by the following formula (1) and a structural unit represented by the following formula (2), wherein
the binder material is a thermoplastic resin, and
a film thickness of the surface layer is 35 μm or larger and 50 μm or smaller, 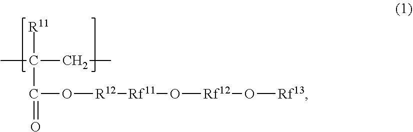
wherein
R¹¹ represents a hydrogen atom or a methyl group,
R¹² represents an ethylene group, a methylene group or a single bond,
Rf¹¹ and Rf¹² each independently represent a perfluoroalkylene group having 1 or more and 5 or less carbon atoms, or a perfluoroalkylidene group having 1 or more and 5 or less carbon atoms, and
Rf¹³ represents a perfluoroalkyl group having 1 or more and 5 or less carbon atoms; and 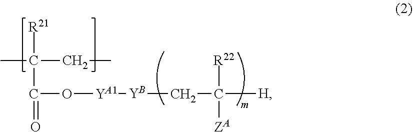
wherein
Y^{A1} represents an unsubstituted alkylene group,
Y^{B} represents an unsubstituted alkylene group, an alkylene group substituted with a halogen atom, an alkylene group substituted with a hydroxy group, an ester bond (—COO—), an amide bond (—NHCO—) or a urethane bond (—NHCOO—), or alternatively a divalent linking group that can be derived from a combination of one or more selected from the above groups and bonds, and —O— or —S—, or alternatively a single bond,
Z^{A} represents a structure represented by the following formula (2A), a cyano group or a phenyl group,
R²¹ and R²² each independently represent a hydrogen atom or a methyl group, and
m is an integer of 25 or larger and 150 or smaller, 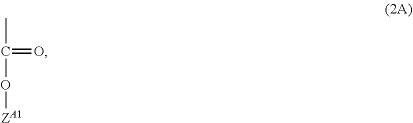
wherein Z^{A1} represents an alkyl group having 1 or more and 4 or less carbon atoms.

12. An electrophotographic apparatus comprising: an electrophotographic photosensitive member comprising a surface layer, a charging unit, an exposure unit, a developing unit and a transfer unit, wherein
the surface layer comprises:
a fluorine atom-containing resin particle;
a binder material;
a charge transport substance; and
a polymer A having a structural unit represented by the following formula (1) and a structural unit represented by the following formula (2), wherein
the binder material is a thermoplastic resin, and
a film thickness of the surface layer is 35 μm or larger and 50 μm or smaller, 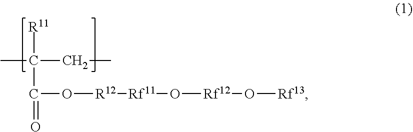
wherein
R¹¹ represents a hydrogen atom or a methyl group,
R¹² represents an ethylene group, a methylene group or a single bond,
Rf¹¹ and Rf¹² each independently represent a perfluoroalkylene group having 1 or more and 5 or less carbon atoms, or a perfluoroalkylidene group having 1 or more and 5 or less carbon atoms, and
Rf¹³ represents a perfluoroalkyl group having 1 or more and 5 or less carbon atoms; and 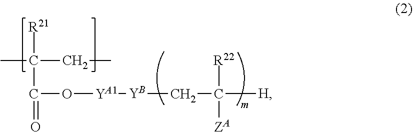
wherein
Y^{A1} represents an unsubstituted alkylene group,
Y^{B} represents an unsubstituted alkylene group, an alkylene group substituted with a halogen atom, an alkylene group substituted with a hydroxy group, an ester bond (—COO—), an amide bond (—NHCO—) or a urethane bond (—NHCOO—), or alternatively a divalent linking group that can be derived from a combination of one or more selected from the above groups and bonds, and —O— or —S—, or alternatively a single bond,
Z^{A} represents a structure represented by the following formula (2A), a cyano group or a phenyl group,
R²¹ and R²² each independently represent a hydrogen atom or a methyl group, and
m is an integer of 25 or larger and 150 or smaller, 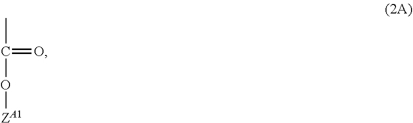
wherein Z^{A1} represents an alkyl group having 1 or more and 4 or less carbon atoms.

13. A method for producing an electrophotographic photosensitive member comprising a surface layer, comprising:
a step of preparing a coating liquid for the surface layer, the coating liquid containing a polymer A having a structural unit represented by the following formula (1) and a structural unit represented by the following formula (2), a fluorine atom-containing resin particle, a binder material, and a charge transport substance, wherein the binder material is a thermoplastic resin; and
a step of forming a coating film of the coating liquid for the surface layer, and drying the coating film to thereby form the surface layer having a film thickness of 35 μm or larger and 50 μm or smaller, 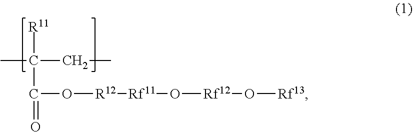
wherein
R¹¹ represents a hydrogen atom or a methyl group,
R¹² represents an ethylene group, a methylene group or a single bond,
Rf¹¹ and Rf¹² each independently represent a perfluoroalkylene group having 1 or more and 5 or less carbon atoms, or a perfluoroalkylidene group having 1 or more and 5 or less carbon atoms, and
Rf¹³ represents a perfluoroalkyl group having 1 or more and 5 or less carbon atoms; and 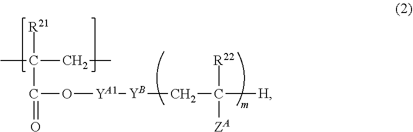
wherein
Y^{A1} represents an unsubstituted alkylene group,
Y^{B} represents an unsubstituted alkylene group, an alkylene group substituted with a halogen atom, an alkylene group substituted with a hydroxy group, an ester bond (—COO—), an amide bond (—NHCO—) or a urethane bond (—NHCOO—), or alternatively a divalent linking group that can be derived from a combination of one or more selected from the groups and bonds, and —O— or —S—, or alternatively a single bond,
Z^{A} represents a structure represented by the following formula (2A), a cyano group or a phenyl group,
R²¹ and R²² each independently represent a hydrogen atom or a methyl group, and
m is an integer of 25 or larger and 150 or smaller, 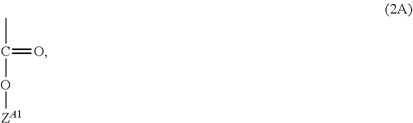
wherein Z^{A1} represents an alkyl group having 1 or more and 4 or less carbon atoms.
